(19) United States
(12) Patent Application Publication
(10) Pub. No.: US 2026/0109870 A1
(43) Pub. Date: Apr. 23, 2026

(54) PEPTIDE-BASED NON-CRYSTALLINE MATERIALS AND COMPOSITIONS AND PROCESSES FOR OBTAINING SAME

(71) Applicant: Ramot at Tel-Aviv University Ltd., Tel-Aviv (IL)

(72) Inventors: Ehud GAZIT, Tel-Aviv (IL); Zohar Albert ARNON, Tel-Aviv (IL); Sharon GILEAD, Tel-Aviv (IL); Gal FINKELSTEIN, Tel-Aviv (IL); Vijayakanth THANGAVEL, Tel-Aviv (IL)

(73) Assignee: Ramot at Tel-Aviv University Ltd., Tel-Aviv (IL)

(21) Appl. No.: 19/117,998

(22) PCT Filed: Oct. 4, 2023
(86) PCT No.: PCT/IL2023/051062

§ 371 Date: Apr. 3, 2025

Related U.S. Application Data
(60) Provisional application No. 63/412,904, filed on Oct. 4, 2022.

(51) Int. Cl. C09D 7/63; C03C 27/10; C09J 5/00; C09J 11/06; G02B 1/04

(52) U.S. Cl. CPC C09D 7/63; C03C 27/10; C09J 5/00; C09J 11/06; G02B 1/041

(57) ABSTRACT

Compositions that comprise a solvent (e.g., an aqueous solvent) and a plurality of aromatic peptides that are soluble in the solvent, and non-crystalline materials formed thereof, which can be glassy and/or adhesive materials, are provided. Uses of the compositions and the non-crystalline materials formed thereof, and articles-of-manufacturing made of the non-crystalline materials are also provided.

### RELATED APPLICATION/S

This application claims the benefit of priority of U.S. Patent Application No. 63/412,904 filed on Oct. 4 2022, the contents of which are incorporated herein by reference in their entirety.

### FIELD AND BACKGROUND OF THE INVENTION

The present invention, in some embodiments thereof, relates to biomaterials, and more particularly, but not exclusively, to compositions that comprise water-soluble aromatic peptides, which can form a non-crystalline (e.g., adhesive and/or glassy) material at ambient conditions, to non-crystalline materials formed of said compositions, to articles-of-manufacturing comprising such non-crystalline materials, and to uses of the compositions and of the non-crystalline materials formed thereof.

One of the major bottom-up approaches for the development of novel organic materials is achieved by exploiting the intrinsic propensity of peptides to self-assemble into ordered structures with enhanced and unique physical, chemical and biological properties [see, for example, Zhang, Nat. Biotechnol. 21, 1171-1178 (2003)]. The dynamic nature of these structures stems from the non-covalent interactions between building blocks, which may facilitate desired attributes, such as self-healing, tunable mechanical and physical properties, and controllable reorganization [Mason et al. ACS Nano 8, 1243-1253 (2014); Burattini et al. Chem. Commun. 44, 6717-6719 (2009); Zhou and Yan, Angew. Chemie Int. Ed. 43, 4896-4899 (2004); Mart et al. Soft Matter 2, 822-835 (2006); Cohen-Gerassi et al. Chem. Mater. 32, 8342-8349 (2020); and Arnon et al. Nat. Commun. 7, 13190 (2016)]. In addition, peptide self-assembled architectures display a variety of other physicochemical properties, such as piezoelectricity, semiconductivity, intrinsic fluorescence, waveguide, and more [Nguyen et al. Nat. Commun. 7, 13566 (2016); Esin et al. Appl. Phys. Lett. 109, 142902 (2016); Akdim et al. Appl. Phys. Lett. 106, 183707 (2015); Pinotsi et al. Chembiochem 14, 846-850 (2013); and Sun et al. ACS Nano 12, 1934-1939 (2018)]. Due to the chemical diversity of the amino acids comprising these peptides, the variety of physicochemical attributes is immense.

The vast majority of peptide-based materials are crystalline. For example, short peptides containing aromatic mnoieties tend to assemble via long-range π-stacking interactions that stabilize close-packing, resulting in high crystallinity and impressive mechanical properties [See, for example, Adler-Abramovich et al., Adv. Mater. 30, 1-6 (2018); Adler-Abramovich et al., Chem. Soc. Rev. 43, 6881-6893 (2014); Lampel et al. Chem. Soc. Rev. 47, 3737-3758 (2018); and Ulijn and Smith, Chem. Soc. Rev. 37, 664-675 (2008)]. Amnorphous peptide-based materials in a stable glassy phase possess an entirely different molecular organization and have not been reported heretofore.

For a self-assembly process to occur, the molecules should first separate into mobile individual building blocks, to allow them to reorganize in a well-ordered fashion. This is usually carried out by dissolving the molecules in a liquid medium. The second step is when the building blocks within the solution can interact with one another to form complexes that are energetically favorable in comparison to the molecule-solvent interactions. This can be accomplished, for example, by: 1) evaporation of the solution to thereby increase the concentration of the building blocks; 2) the solvent-switch method, in which the dissolved building block solution is mixed with a different solvent in which the peptide building blocks have poor solubility; 3) the heat-switch method, in which the building blocks dissolution is assisted by heat energy, and the obtained solution is allowed to cool down in order to decrease the solubility capacity of the solvent. Thus, the solubility of a building block in a given solvent is an important parameter in the self-assembly process.

In most cases, the solubility of a peptide could be roughly estimated from the identity of the amino acids within the peptide sequence. In the general case of water as a solvent, hydrophilic amino acids will promote solubility, while hydrophobic residues will impede solubility. However, the principles of amino acid and peptide solubility are not always as straightforward as thought to be. For example, phenylalanine (F), a hydrophobic single amino acid with an aromatic residue, dissolves in water at room temperature at a concentration of up to 29.6 mg/mL (179.19 mM), while tyrosine (Y), a similar amino acid that is considered less hydrophobic due to the hydroxyl group on the aromatic ring, dissolves in water at a concentration of 0.45 mg/mL (2.38 mM) [Ji et al. ACS Nano 13, 14477-14485 (2019)].

This trend of dissolving a single amino acid in water is considered as unexpected; it was explained by taking into account the complexity of the building blocks dissolved, i.e., the amino acids. In this case, F molecules dissolve as the single amino acids, yet, each Y molecule is associated with another Y molecule to form a tightly packed dimer, stabilized by the hydroxyl group interactions. As the two tyrosines in the dimer are not separated by the water molecules in the solution, the Y-Y dimer is the dissolved building block. Since the hydroxyl groups are occupied by bonding with other Y molecules, the Y dimer is less prone to form hydrogen bonding with surrounding water molecules, thus its solubility substantially decreases [Ji et al. (2019), supra].

In the case of molecules longer than single amino acids, such as peptides, the commonly used methods for estimating solubility are accomplished by assessing the chemical identity of the amino acid residues, regardless of the order in which they are sequenced.

Adhesive substances are essential materials in various industries. Adhesion between interfaces of similar or dissimilar materials can be achieved by effective hydrogen, covalent, and/or electrostatic bonding between an adhesive composition and the adhered substrates.

Currently known bioadhesives are either adhesive polymers secreted from natural resources or biomimetic alternatives made of synthetic compositions comprising naturally occurring components, such as carbohydrates (e.g., starch) and proteins (e.g., gelatin).

Glass displays the mechanical properties of a solid, but exhibits the atomic organization of a kinetically-trapped liquid [Zanotto and Mauro, J. Non. Cryst. Solids. 471, 490-495 (2017)]. Such a random molecular arrangement is achieved by inhibiting the thermodynamically favorable periodic organization, usually by a fast rate cooling of a melt matter. Glassy architectures can be readily constructed from polymers due to the entanglement or crosslinking of long polymeric chains, which lowers their molecular mobility. Due to their fixed molecular organization, glassy polymers show remarkable stiffness, but consequently are unable to self-heal once damaged below their glass transition temperature due to their sluggish nolecular diffusion rate [Wang et al., Proc. Natl. Acad. Sci. U.S.A 117 (2020), doi:10.1073/pnas.2000001117]. On the other hand, rubbery polymers composed of low molecular weight molecules are able to self-heal due to their high molecular mobility, but are soft and deformable at room temperature. Accordingly, a glassy material, which simultaneously shows robust mechanical properties and has the ability to self-heal, is extraordinary [Yanagisawa et al. Science (80) 359, 72-76 (2018); Huang et al. Nat. Mater. 21, 103-109 (2022)].

Various small organic molecules are able to assemble into amorphous solids through non-covalent bonding despite their high molecular mobility [Lebel and Soldera, Adv. Mater., 239-260 (2019); Wuest and Lebel, Tetrahedron. 65, 7393-7402 (2009)]. For the formation of a molecular glass, the non-covalent intermolecular interactions must be strong and tight, yet not oriented, in order to construct a supramolecular structure without a defined order that hinders the formation of an ordered structure.

Additional background art includes International Patent Application Nos. PCT/IL2006/001174 (published as WO 2007/043048), PCT/IL2011/000435 (published as WO 2011/151832), PCT/IL2018/050773 (published as WO 2019/012545), and PCT/IL2019/050788 (published as WO 2020/012490), Adler-Abramovich & Gazit [Chem Soc Rev 2014, 43, 6881-6893]; Dudukovic & Zukoski [Langmuir 2014, 30:4493-4500]; Fleming & Ulijn [Chem Soc Rev 2014, 43, 8150-8177]; Hauser & Zhang [Chem Soc Rev 2010, 39, 2780-2790]; Jayawarna et al. [Adv Mater 2006, 18:611-614]; Jayawarna et al. [Acta Biomater 2009, 5:934-943]; Orbach et al. [Biomacromolecules 2009, 10, 2646-2651]; Orbach et al. [Biomacromolecules 2012, 28:2015-2022]; Panda et al. [ACS Appl Mater Interfaces 2010, 2, 2839-2848]; RoseFigura et al. [Biochemistry 2011, 50, 1556-1566]; Schnaider et al. [Nano Lett 2020, 20:1590-1597]; Smith et al. [Adv Mater 2008, 20:37-41]; Ulijn & Smith [Chem Soc Rev 2008, 37, 664-675]; Widboom et al. [Nature 2007, 447, 342-345]; Yang et al. [JMater Chem 2007, 17, 850-854]; Chaplin, Nat. Rev. 7, 861-866 (2006); Ihli et al. Nat. Commun. 12, 25613-25614 (2021); and Zhang [Interface Focus 2017, 7, 20170028], all being incorporated by reference as if fully set forth herein.

### SUMMARY OF THE INVENTION

According to an aspect of some embodiments of the present invention there is provided a composition comprising a plurality of peptides and an aqueous solvent, wherein in at least a portion of the plurality peptides, each peptide is independently an aromatic peptide of from 2 to 6 amino acid residues, in which at least two of the amino acid residues are each independently an aromatic amino acid residue, wherein at least one of the aromatic amino acid residues is tyrosine or an analog thereof, and wherein the aromatic peptide features a solubility of at least 100 mg/ml, or at least 200 mg/ml, or at least 500 mg/ml or at least 1,000 mg/ml, at 25° C., in the solvent.

According to some of any of the embodiments described herein, each of the aromatic peptides is independently an aromatic di-peptide or an aromatic tri-peptide.

According to some of any of the embodiments described herein, each of the aromatic amino acid residues in each of the aromatic peptides is independently selected from a phenylalanine residue and a tyrosine residue and analogs thereof.

According to some of any of the embodiments described herein, at least 50% of the aromatic amino acid residues in each of the aromatic peptides are each independently selected from tyrosine residues and analogs thereof.

According to some of any of the embodiments described herein, each of the tyrosine residues and the analogs thereof is independently represented by Formula I, as described herein in any of the respective embodiments and any combination thereof.

According to some of any of the embodiments described herein, each of the aromatic peptides is independently selected from FY, YF, YY, FFY, YFF, FYY, YFY, YYF and YYY.

According to some of any of the embodiments described herein, each of the aromatic peptides is independently selected from FY, YF, YY, FYY, YFY, YYF and YYY.

According to some of any of the embodiments described herein, the composition is an aqueous solution.

According to some of any of the embodiments described herein, a concentration of the plurality of peptides in the composition ranges from 0.1 to 100% of its solubility in water.

According to some of any of the embodiments described herein, the composition is capable of forming a rigid material upon evaporation of the aqueous solvent, or once the solvent evaporates.

According to some of any of the embodiments described herein, the composition is an adhesive composition, and can be regarded, for example, as a peptidic glue or as a biological glue or as a biodegradable glue.

According to an aspect of some embodiments of the present invention there is provided a material comprising a plurality of peptides as defined in any of the respective embodiments and any combination thereof, assembled into a non-crystalline structure.

According to some of any of the embodiments described herein, the material further comprises molecules of a solvent as described herein in any of the respective embodiments, and in some embodiments, the solvent molecules are associated with the plurality of the peptides in the non-crystalline structure.

According to some of any of the embodiments described herein, the material is a transparent material.

According to some of any of the embodiments described herein, the material is a glassy material characterized by a glass transition temperature (Tg) higher than room temperature, or higher than 30° C.

According to some of any of the embodiments described herein, the material is characterized by Tg that ranges from room temperature to about 50° C. in an environment featuring a relative humidity of at least 50%.

According to some of any of the embodiments described herein, the material is characterized by at least one of: Tg of at least 50, or at least 100, ° C.; hardness that ranges from 500 to 1,000 MPa; and reduced modulus of elasticity that ranges from 1 to 20 GPa, in an environment featuring a relative humidity lower than 30%.

According to some of any of the embodiments described herein, the self-assembled structure further comprises water molecules associated with at least a portion of the peptides.

According to some of any of the embodiments described herein, a mol ratio of the water molecules and the peptides is higher than 5:1 or higher than 10:1, the material being characterized by Tg that ranges from room temperature to about 50° C.

According to some of any of the embodiments described herein, a mol ratio of the water molecules and the peptides is lower than 5:1, the material being characterized by at least one of: Tg of at least 50, or at least 100, ° C. (e.g., of from 100 to 150° C.); hardness that ranges from 500 to 1,000 MPa; and reduced modulus of elasticity that ranges from 1 to²0 GPa, According to some of any of the embodiments described herein, the material is a self-healing glassy material, capable of diminishing cracks formed therein by exposure to an environment that features a relative humidity higher than 50%.

According to some of any of the embodiments described herein, the material is characterized by a cohesive strength, when applied between two surfaces (e.g., hydrophilic surfaces), in a range of from 200 to 800, or from 250 to 600, or from 300 to 500 kilopascal (kPa).

According to some of any of the embodiments described herein, the cohesive strength is maintained at a temperature in the range of from −200 to 200° C.

According to an aspect of some embodiments of the present invention there is provided a method of forming a layer of a rigid, non-crystalline peptide material on a surface of a substrate, the method comprising applying the composition as described herein in any of the respective embodiments and any combination thereof on the surface of the substrate to thereby form a layer of the material on the surface of the substrate.

According to some of any of the embodiments described herein, the non-crystalline peptide material is formed once the solvent evaporates.

According to some of any of the embodiments described herein, the solvent evaporates at a temperature in a range of from room temperature to a boiling temperature of the solvent, at ambient pressure.

According to some of any of the embodiments described herein, the material is capable of increasing a light transmittance of the substrate.

According to an aspect of some embodiments of the present invention there is provided a substrate having applied on at least a portion of a surface thereof the non-crystalline material as described herein in any of the respective embodiments and any combination thereof.

According to an aspect of some embodiments of the present invention there is provided a method of adhering at least two substrates to one another, the method comprising contacting at least a portion of a surface of each of the substrates with the composition as described herein in any of the respective embodiments and any combination thereof. In some embodiments, the substrates are adhered to one another once the solvent evaporates.

According to an aspect of some embodiments of the present invention there is provided an article-of-manufacturing comprising at least two substrates and a non-crystalline material as defined herein in any of the respective embodiments and any combination thereof being in contact with at least a portion of a surface of each of the at least two substrates.

According to an aspect of some embodiments of the present invention there is provided an article-of-manufacturing comprising the non-crystalline material as defined herein in any of the respective embodiments and any combination thereof.

According to some of any of the embodiments described herein, the article-of-manufacturing is or comprises an optical lens.

According to some of any of the embodiments described herein, the article-of-manufacturing is selected from an optical system, a textile product, a packaging, a transportation vehicle, a component of an agricultural machinery and equipment, an aerospace system or vehicle, a construction component, an electronic product, a personal care product, an agricultural product, a cleaning product, a biomedical product, a houseware product, and an antimicrobial product.

According to an aspect of some embodiments of the present invention there is provided a biodegradable self-healing, glassy material.

Unless otherwise defined, all technical and/or scientific terms used herein have the same meaning as commonly understood by one of ordinary skill in the art to which the invention pertains.

Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 presents the chemical structures of phenylalanine and tyrosine, and of di- and tri-peptides consisting of these residues.

FIGS. 2A-2F present light microscopy images (FIGS. 2A-C) and powder X-ray diffraction spectra (XRDP; FIGS. 2D-F) of untreated powder and a lyophilized sample (obtained upon contacting with water and water evaporation) of the tri-peptides FFY (FIGS. 2A and 2D), YFF (FIGS. 2B and 2E) and FYF (FIGS. 2C and 2F).

FIGS. 3A-3H describe the glass-like characteristics of the dry exemplary peptide material (a dried solution of the exemplary peptide) according to some of the present embodiments, YYY. FIG. 3A is a photograph showing two microscope slides held together with a thin film formed of a YYY aqueous solution upon spontaneous water evaporation. The partially-overlapping section is 25 millimeter (mm) by 25 mm. FIG. 3B presents a photograph of the dried YYY, showing its shard features that resemble those of glass. FIG. 3C presents comparative plots showing the visible light transmittance (VLT) spectrum of the overlapping section between glass slides and the adhesive YYY film shown in FIG. 3A (grey), and of the overlapping glass slides with evaporated water in between, as a control (black). FIG. 3D presents comparative plots showing powder X-ray diffraction (XRD) patterns of the untreated YYY white powder (black) and the dried glass-like YYY sample (grey). FIG. 3E presents a differential scanning calorimetry (DSC) thermogram of the glass-like YYY sample obtained following drying at ambient conditions, shown in FIG. 3B; Thermograms were measured at a temperature of from −40° C. to 120° C. at a heating rate of 10° C./minute; Tg denotes the glass transition. FIG. 3F presents comparative plots showing the visible light transmittance (VLT) spectrum and the infrared (IR) transmittance spectrum of the overlapping section between zinc sulfide multispectral plates having the adhesive YYY film (grey) or evaporated water (black; control) therebetween. FIG. 3G presents the refractive index of the dried YYY peptide in the 400 to 800 nm visible range, which is determined as 1.52 by ellipsometry. FIG. 3H is a schematic illustration showing the intermolecular hydrogen bonds between water molecules and the exemplary YYY molecular structure, as confirmed by ‘H—’H Nuclear Overhauser Effect Spectroscopy (NOESY) experiment conducted on a sample of the exemplary glass-like YYY peptide assembled by evaporating the aqueous solution and dissolving in DMSO-d₈ (not shown).

FIGS. 4A-4D present adhesive performance tests of an exemplary water-based adhesive composition according to some of the present embodiments, containing YYY as an exemplary adhesive peptide. FIG. 4A is a photograph showing that 1 milligram (mg) of a dried YYY water-based adhesive is holding a microscope slide perpendicular to another microscope slide. FIG. 4B is a photograph showing that a thin adhesive film formed of a YYY solution between two slides with an overlapping area of 25 squared mm is capable of holding 5 kilogram weights. FIG. 4C is a photograph showing an exemplary experimental set-up for single lap shear test measurements, showing the two partially-overlapping adhered slides firmly fastened between two screw side action grips, before being pulled apart using a 10 kN load cell at a cross speed of 1 mm/minute.

FIG. 4D is a stress-strain curve obtained from a representative single lap measurement (shown in FIG. 4C), showing the shear measurement of the load (N) as a function of a displacement of the load cell (mm).

FIG. 4E is a representative illustration of the implementation of the exemplary YYY peptide solution on hydrophilic microscope glass slides, resulting in the formation of a YYY adhesive peptide film between two glass slides.

FIG. 4F is a photograph of a wetting experiment showing the wetting angle of water (left) and a YYY peptide solution (right) on a glass surface.

FIG. 4G presents optical microscope images showing a water adsorption process, starting from a raw YYY powder and changing to a clear highly viscous mater under saturated humid environment, demonstrating the hydroscopic nature of the YYY peptide. Scale bar 500 μm. Time scale 2.5 hours.

FIGS. 5A-D present the optical properties of the glass-like exemplary peptide YYY according to some of the present embodiments. FIG. 5A is a photograph showing that a solid YYY peptide glassy material obtained upon solidifying on top of a hydrophobic PDMS substrate resembles an optical lens. FIG. 5B are photographs of custom Teflon (PTFE)-coated glass slide with circular wells, as a template for uniform diameter peptide lens fabrication (upper image), and a side-view photograph showing that the curvature of the resulting lens is dependent on the initial volume used in the well (bottom image). FIG. 5C presents a schematic illustration and related equation used in the calculation of the focal length according to the optical setup. FIG. 5D are photographs showing the varying focal length obtained for lenses produced from different volumes of a YYY solution (100 mg/ml), compared to no lens (upper panel); The sharpest images obtained for each tested peptide lens are marked by a surrounding dashed rectangle.

FIGS. 6A-G present data showing the dynamic modulation of the mechanical properties of the exemplary YYY glassy material in response to water content. FIG. 6A is a photograph of a glass-like YYY material following tensile test, showing ductile behavior. FIG. 6B presents a cryogenic scanning electron microscopy (Cryo-SEM) image of a hydrated sample showing ductile behavior. FIG. 6C-D are a photograph (FIG. 6C) and a scanning microscopy (SEM) image (FIG. 6D) of the glass-like YYY material upon drying, showing brittle behavior. FIG. 6E presents comparative differential scanning calorimetry (DSC) thermograms of the dried glass-like YYY material, measured in several heating cycles (from 0 to 70, 100, 110, and 120° C., at a rate of 10° C./minute; a 10-minute isothermal was set at the end of each cycle). FIG. 6F presents differential scanning calorimetry (DSC) thermogram measurements of the dried YYY material, indicating a glass transition at 119° C. FIG. 6G is a schematic illustration of the reversible process which occurs in the exemplary YYY glassy material upon hydration/dehydration.

FIG. 7 presents a series of photographs of the glass-like YYY material following dehydration (upper panel) and subsequent hydration (lower panel), showing the formation of cracks during dehydration and self-healing under humid environment. Time scale: 20 sec. Size scale: 500 μm.

FIG. 8A is a schematic illustration of the YYY peptide solution implementation on a hydrophobic substrate (left), which results in a detachable intact glassy material (middle) and an illustration of indentation trace application (right).

FIGS. 8B-E are optical microscope images showing the self-healing process of the exemplary YYY material by creeping mechanism, as described herein. Time scale: 5 days. Size scale: 500 μm.

FIG. 8F is a photograph showing the macroscopic appearance of a solid YYY thin layer peptide glass obtained through a creeping mechanism activated by the external loading of a top hydrophobic polydimethylsiloxane (PDMS) substrate (as shown in FIG. 8B-E).

### DESCRIPTION OF SPECIFIC EMBODIMENTS OF THE INVENTION

The present invention, in some embodiments thereof, relates to biomaterials, and more particularly, but not exclusively, to compositions that comprise water-soluble aromatic peptides, which can form a non-crystalline (e.g., adhesive and/or glassy) material at ambient conditions, to non-crystalline materials formed of said compositions, to articles-of-manufacturing comprising such non-crystalline materials, and to uses of the compositions and of the non-crystalline materials formed thereof.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

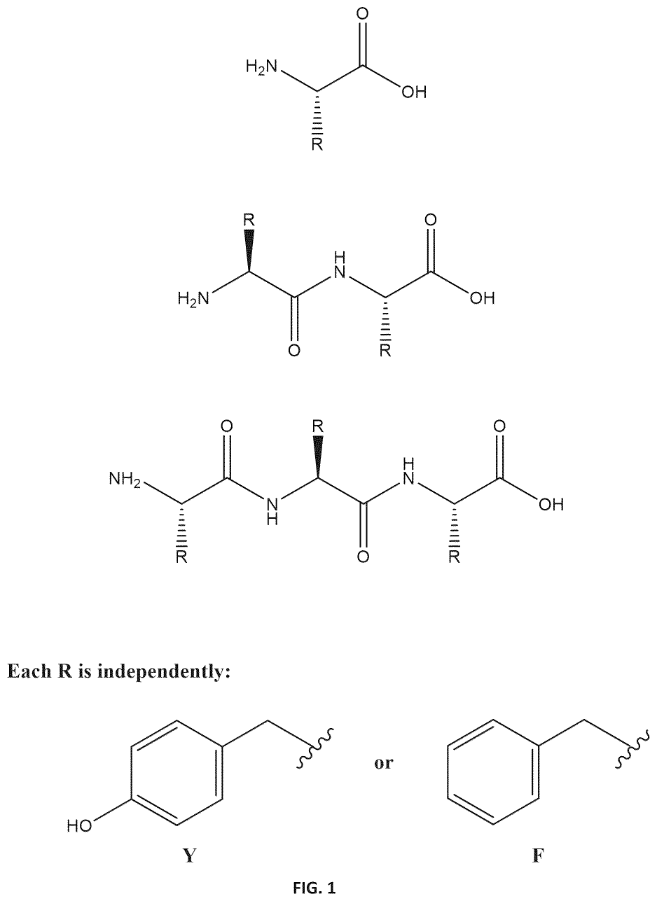

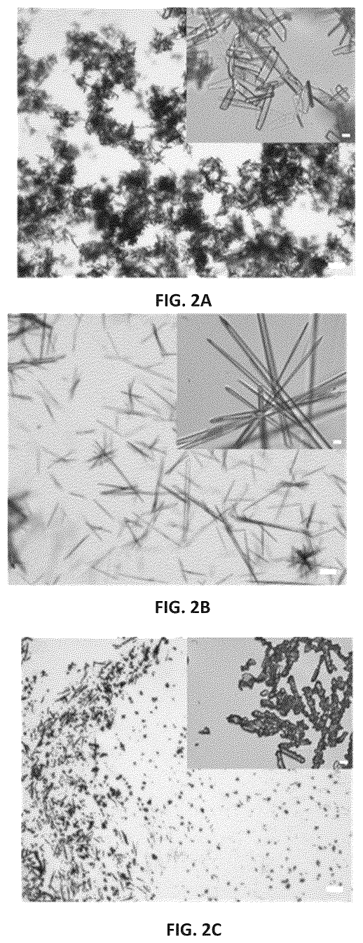

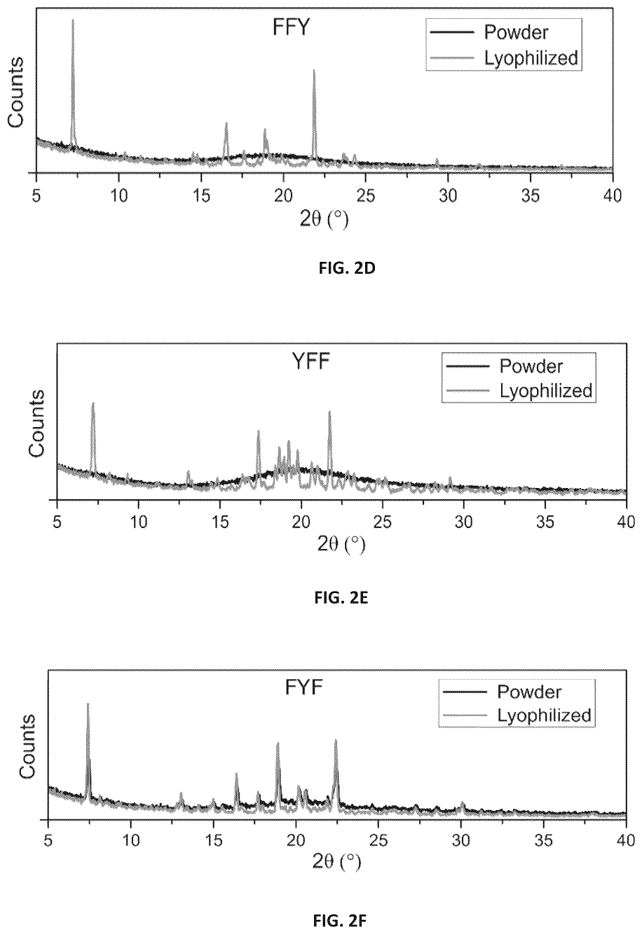

The present inventors have studied the solubility of di- and tri-peptides comprised of phenylalanine (F) and/or tyrosine (Y) amino acids (see, FIG. 1), and have uncovered that the amino acid sequence, including the order of the amino acid residues and their identity, affects the solubility of such peptide building blocks. It was uncovered that tyrosine-containing short peptides can be extremely soluble in water, orders of magnitude higher than the tyrosine single amino acid (see, Table 1). Serendipitously, the present inventors have uncovered that solutions of such exemplary tyrosine-containing short peptides resulted, following water evaporation, in self-assembled structures (FIGS. 2A-F) having increased water-solubility compared to an intact peptide powder.

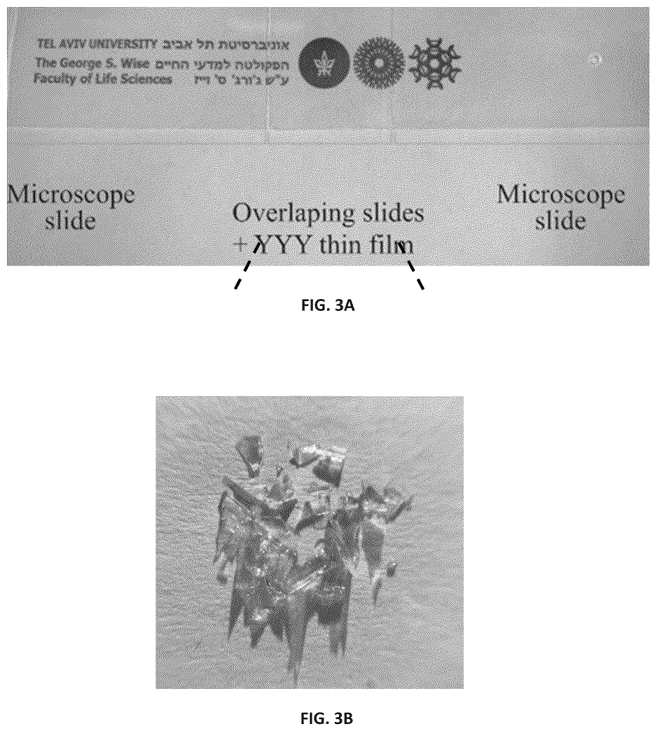

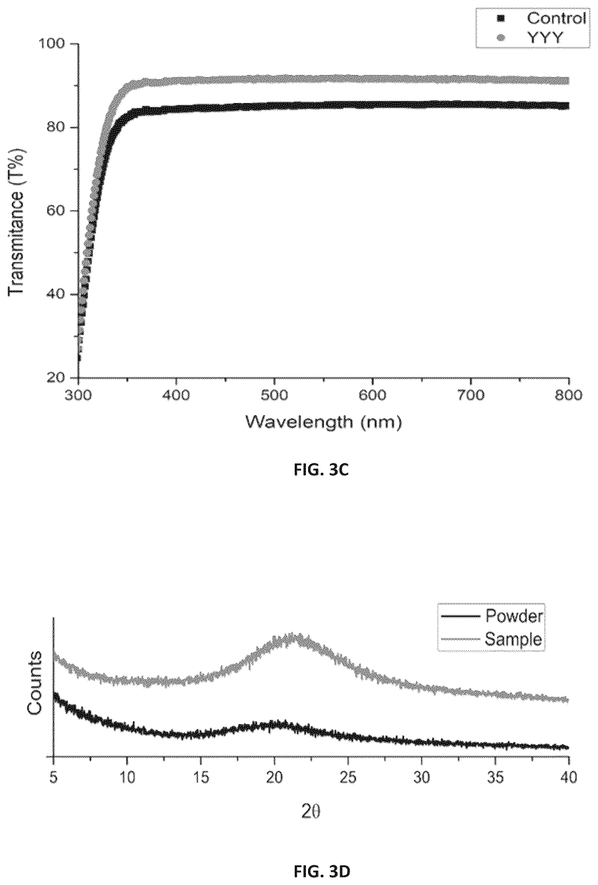

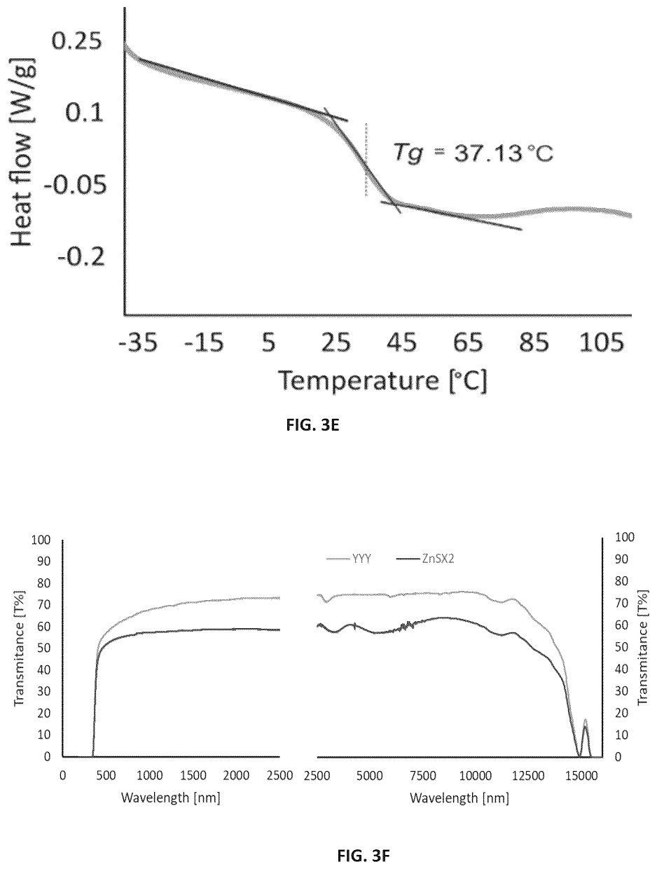

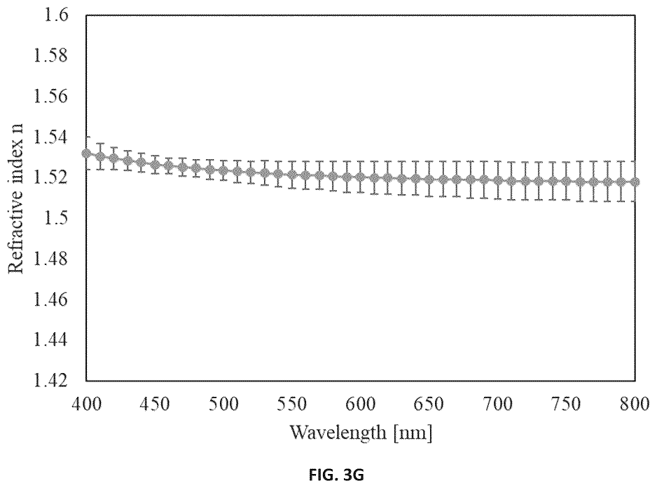

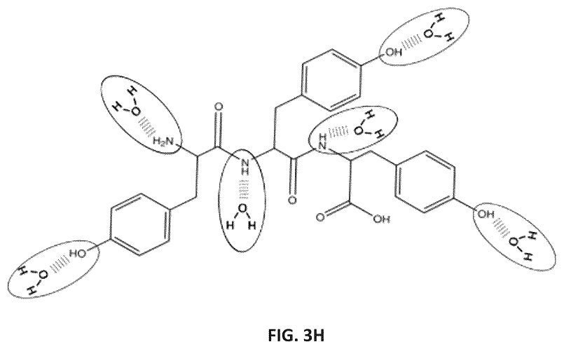

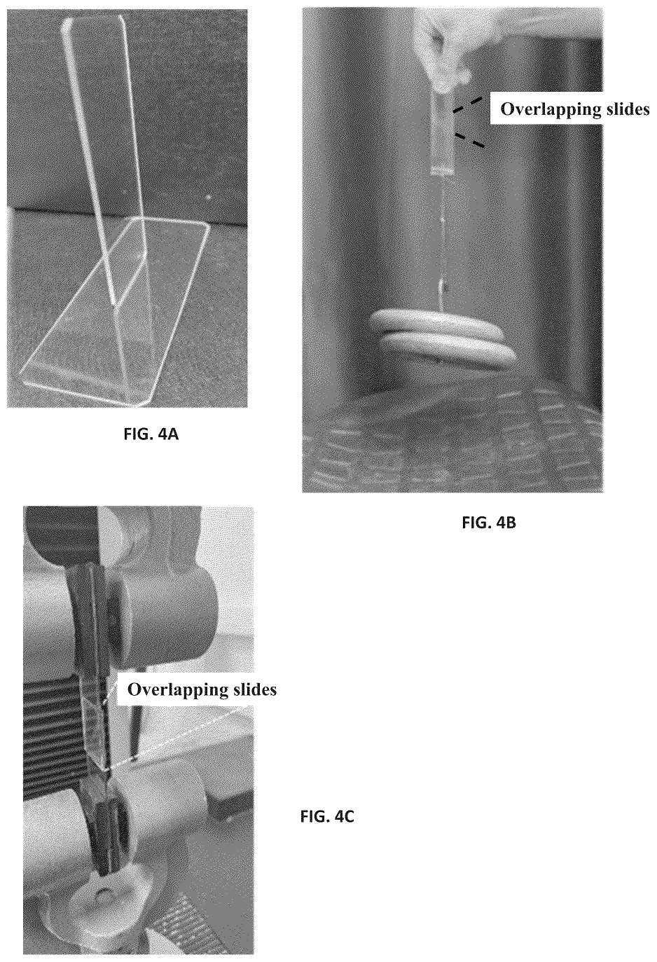

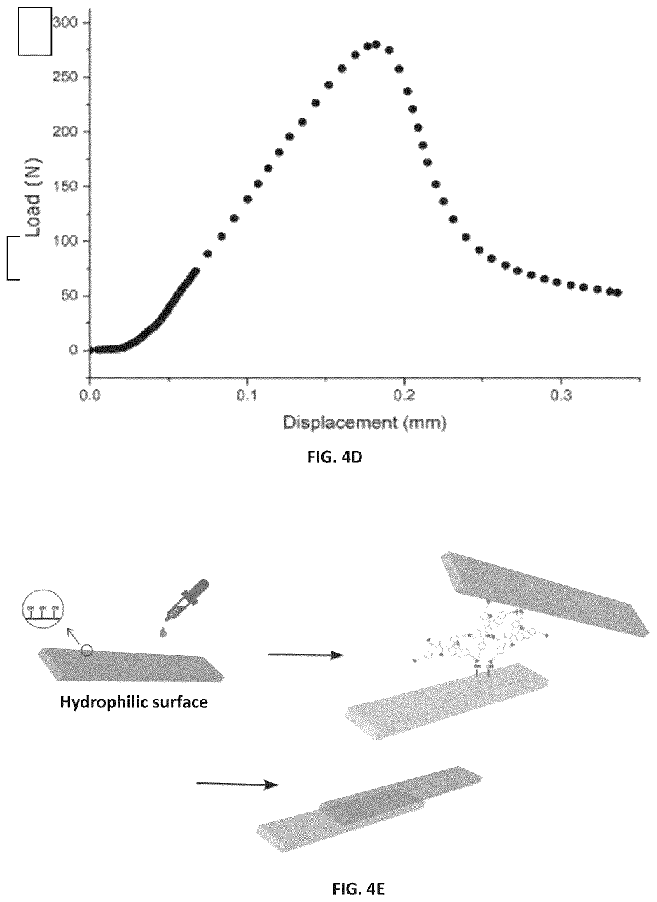

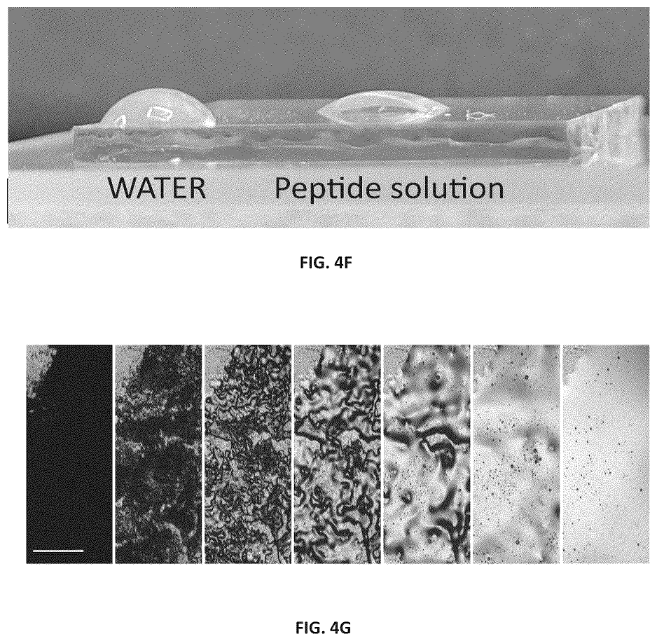

Surprisingly, it was uncovered that an aqueous solution of an exemplary tyrosine-containing tripeptide, YYY, can form, upon water evaporation, a transparent, thermally-stable, glassy hardened material (FIGS. 3A-G), which adheres strongly to hydrophilic surfaces such as glass (FIGS. 4A-E), indicating a promising use of aromatic peptide-based self-assembling systems as adhesive biomaterials in various biomedical and industrial applications.

The novel adhesive compositions provide non-toxic and environment-friendly adhesion between surfaces in a dried environment. The formed adhesive material advantageously features transparency, non-flammability, and thermal stability.

Overall, simple synthetic peptides that include F and Y residues, at defined proportions, were shown to be highly soluble in water, and to strongly adhere upon dehydration to substrates such as glass. The obtained dried peptide materials are colorless, transparent, and rigid, are usable as water-based bioadhesives or as optical lenses, and demonstrate self-healing properties.

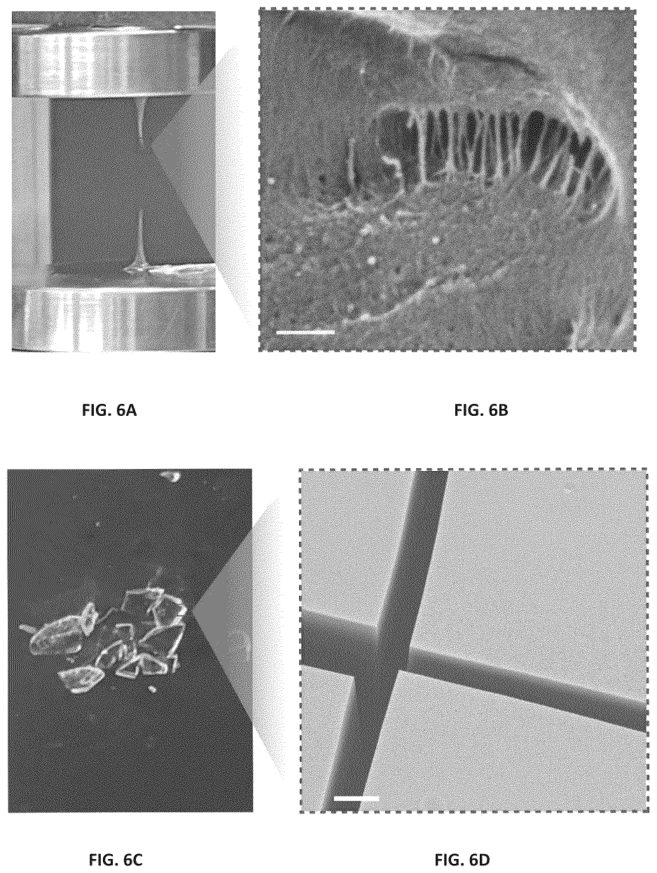

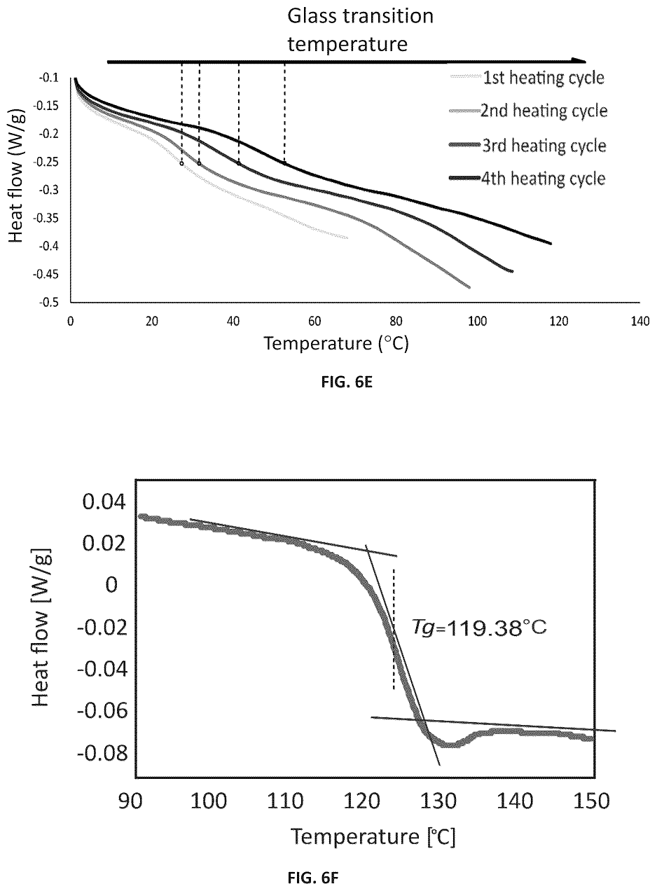

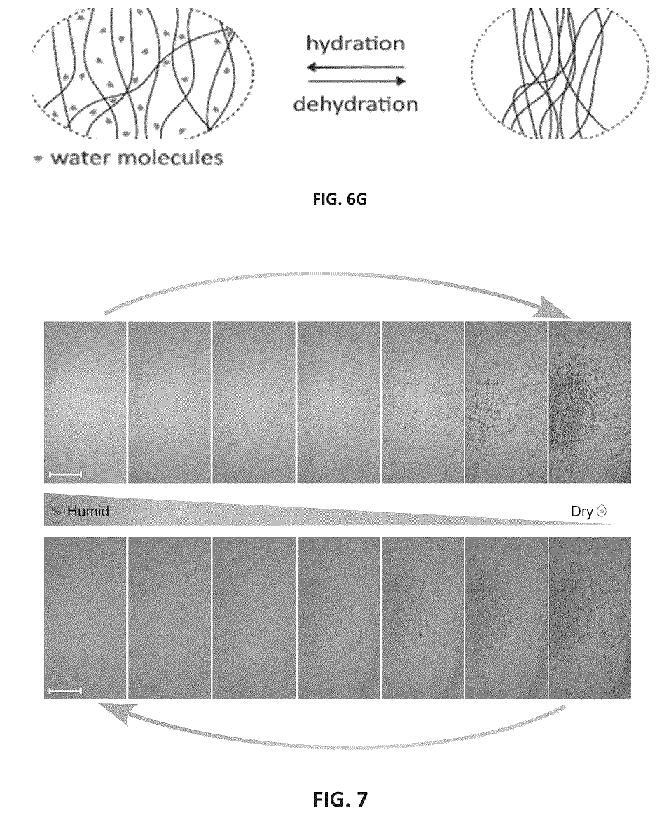

While further studying the characteristics of the self-assembled glassy material, the present inventors have shown that the formation of the hardened material is facilitated by non-covalent cross-linking by water molecules. The water molecules stabilize the structure by enabling strong intermolecular hydrogen bond interactions (FIG. 3H), resulting in robust mechanical properties. It has been shown that the water molecules play a dual role by acting also as a plasticizer, enabling efficient mediation of the glass mechanical properties. When hydrated, the peptide glass exhibits flexible, rubbery, and adhesive properties, which facilitate the ability to self-heal cracks. In contrast, when dehydrated, it shows brittleness and robust mechanical properties, as a result of strong intermolecular bonds facilitated by structural water molecules (FIGS. 6A-G and 7).

An exemplary tripeptide, YYY, which was shown to form a supramolecular amorphous glassy material, when in its lyophilized, is a white solid powder without viscous or adhesive properties in its initial powder state. Yet, hydration initiates the formation of strong non-covalent crosslinking by water molecules resulting in a supramolecular glassy material with inherent polymeric characteristics, despite the remarkable low molecular weight of the peptide building blocks. See, for example, FIGS. 6A-G.

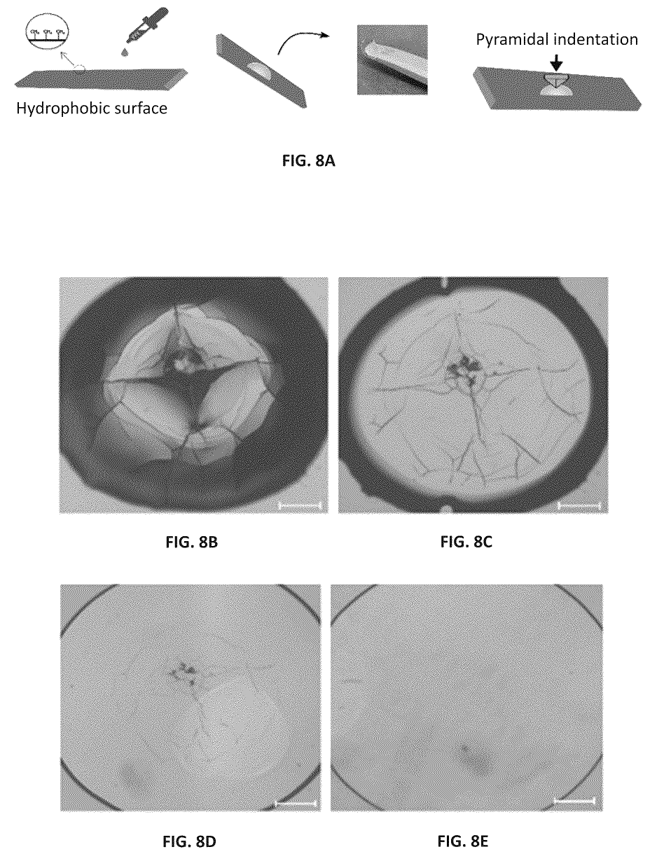

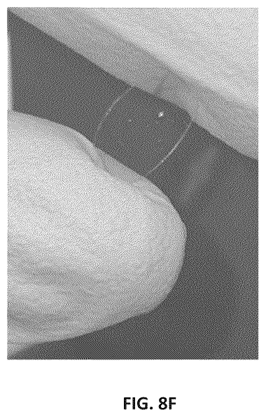

The unique architecture formed by the integration of structural water molecules, as well as their plasticizing property, offers a variety of attractive features. It allows the selective adhesion towards hydrophilic surfaces, the dynamic modulation of the mechanical properties from brittle to ductile, and the ability to self-heal under mild conditions, as shown, for example, in FIGS. 7 and 8A-E.

In addition, the dynamic nature of the peptide glass benefit from allowing it to be recycled. Since most glassy materials are non-degradable, the development of biodegradable and recyclable alternatives is of utmost importance.

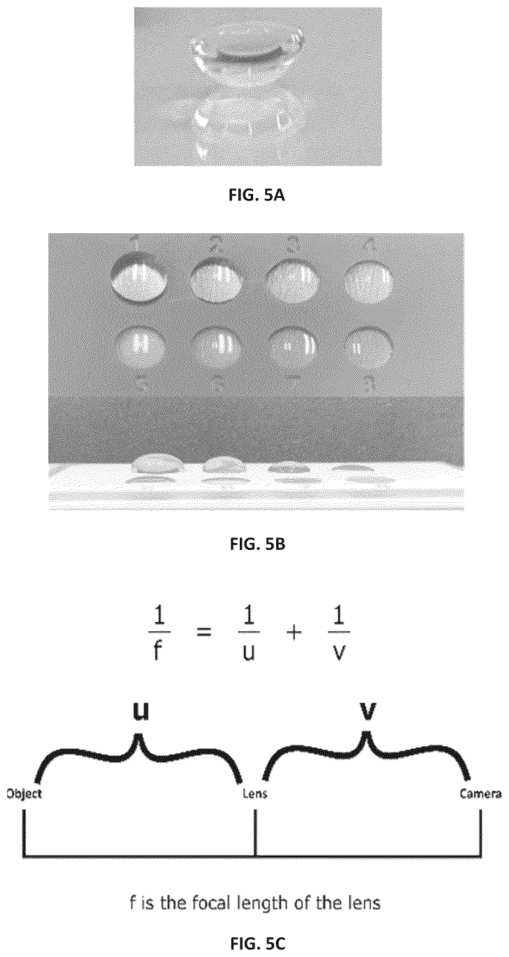

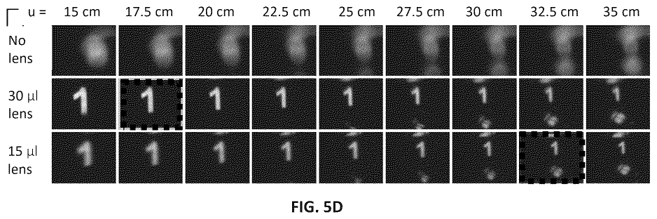

The broad range transparency together with refractive index matching of the peptidic glassy material can be extremely useful for diverse applications in optics and electro-optics manufacturing, as well as other applications, as described in further detail hereinunder. It can be applied as an adhesive of multi-layer optics, as an optic immersion glue, or for facile manufacturing of optical lenses by bottom-up approach, as shown, for example, in FIGS. 5A-D. The self-healing property is particularly advantageous from an engineering perspective, defining an extraordinary multi-functional glassy material.

Embodiments of the present invention therefore relate to novel compositions that comprise water-soluble short aromatic peptides, to rigid (hard or hardened) materials formed thereby and to uses thereof.

More specifically, some embodiments of the present invention relate to an aqueous composition that comprises short peptides of at least two aromatic amino acid residues as described herein and an aqueous solvent such as water, which can be utilized as an adhesive composition, to the adhesive material formed upon dehydration (removing a portion of the aqueous solvent) of the adhesive composition, to methods of forming an adhesive material on a surface of a substrate, and to substrates and articles-of-manufacturing comprising the adhesive material. Some embodiments of the present invention relate the use of an aqueous composition as described herein for forming a glassy material, to the glassy material formed upon dehydrating (removing a portion of the aqueous solvent) the composition, and to articles-of-manufacturing comprising the glassy material.

The composition:

According to an aspect of some embodiments of the present invention there is provided a composition comprising a peptide and a solvent. According to some of any of the embodiments described herein the peptide is a short peptide, for example, of from 2 to 6 amino acid residues. According to some of any of the embodiments described herein, the peptide is an aromatic peptide, which comprises at least one aromatic amino acid residue as defined herein. According to some of any of the embodiments described herein, at least two of the amino acid residues in the peptide are each independently an aromatic amino acid residue. According to some of any of the embodiments described herein, at least one of the aromatic amino acid residues is tyrosine or an analog thereof. According to some of any of the embodiments described herein, the peptide is soluble in the solvent such as water, for example, it features a solubility of at least 100 mg/ml, or at least 200 mg/ml, or at least 500 mg/ml or at least 1,000 mg/ml, at 25° C., in the solvent (e.g., water).

According to an aspect of some embodiments of the present invention there is provided a composition comprising a plurality of peptides and a solvent. According to some of any of the embodiments described herein at least a portion (e.g., at least 50%, 80%, or 90%) of the peptides are each independently a short peptide, for example, of from 2 to 6 amino acid residues. According to some of any of the embodiments described herein, at least a portion (e.g., at least 50%, 80%, or 90%) of the peptides are each independently an aromatic peptide, which comprises at least one aromatic amino acid residue as defined herein. According to some of any of the embodiments described herein, the plurality of peptides is soluble in the solvent, for example, it features a solubility of at least 100 mg/ml, or at least 200 mg/ml, or at least 500 mg/ml or at least 1,000 mg/ml, at 25° C., in the solvent (e.g., water).

According to an aspect of some embodiments of the present invention there is provided a composition comprising a plurality of peptides, at least a portion (e.g., at least 50%, 80%, or 90%) or each of the peptides is independently a peptide of from 2 to 6 amino acid residues, at least two of the amino acid residues are each independently an aromatic amino acid residue, and at least one of the aromatic amino acid residues is tyrosine or an analog thereof, as described herein, and a solvent. According to some of any of the embodiments described herein, the peptides are selected such that a solubility of the plurality of the peptides in the solvent is at least 100 mg/ml, or at least 200 mg/ml, or at least 500 mg/ml or at least 1,000 mg/ml, at 25° C. According to some of these embodiments, the solvent is an aqueous solvent (e.g., water) and the plurality of the peptides comprises water-soluble peptides featuring a solubility in water at least 100 mg/ml, or at least 200 mg/ml, or at least 500 mg/ml or at least 1,000 mg/ml, at 25° C.

According to an aspect of some embodiments of the present invention, there is provided a peptide of from 2 to 6 amino acid residues, at least two of the amino acid residues are each independently an aromatic amino acid residue, and at least one of the aromatic amino acid residues is tyrosine or an analog thereof, as described herein, the peptide being soluble in an aqueous solvent as described herein, that is, the peptide features in an aqueous solvent such as water a solubility (e.g., water solubility) of at least 100 mg/ml, or at least 200 mg/ml, or at least 500 mg/ml or at least 1,000 mg/ml, at 25° C.

Herein throughout, a peptide that comprises from 2 to 6 amino acid residues, in which at least two of the amino acid residues are each independently an aromatic amino acid residue, as described herein in any of the respective embodiments and any combination thereof, is also referred to herein as an “aromatic peptide”.

The phrase “aromatic amino acid residue”, as used herein, refers to an amino acid residue that has an aromatic or heteroaromatic moiety in its side-chain. Of the naturally-occurring amino acids, phenylalanine, tyrosine and tryptophan are considered aromatic amino acid residues. In exemplary embodiments, the aromatic amino acid residue has an aromatic moiety in its side chain. In exemplary embodiments, the aromatic amino acid residue is selected from phenylalanine and tyrosine and analogs thereof, as described herein.

As used herein, the phrase “aromatic moiety” describes a monocyclic or polycyclic moiety having a completely conjugated pi-electron system. The aromatic moiety can be an all-carbon moiety or can include one or more heteroatoms such as, for example, nitrogen, sulfur or oxygen. The aromatic moiety can be substituted or unsubstituted, whereby when substituted, the substituent can be, for example, one or more of alkyl, trihaloalkyl, alkenyl, alkynyl, cycloalkyl, aryl, heteroaryl, heteroalicyclic, halo, nitro, azo, hydroxy, alkoxy, thiohydroxy, thioalkoxy, cyano and amine, as defined herein.

Exemplary aromatic moieties include, for example, phenyl, biphenyl, naphthalenyl, phenanthrenyl, anthracenyl, [1,10]phenanthrolinyl, indoles, thiophenes, thiazoles and, [2,2′]bipyridinyl, each being optionally substituted. Thus, representative examples of aromatic moieties that can serve as the side chain within the aromatic amino acid residues described herein include, without limitation, substituted or unsubstituted naphthaleny, substituted or unsubstituted phenanthrenyl, substituted or unsubstituted anthracenyl, substituted or unsubstituted [1,10]phenanthrolinyl, substituted or unsubstituted [2,2′]bipyridinyl, substituted or unsubstituted biphenyl and substituted or unsubstituted phenyl. The aromatic moiety can alternatively be substituted or unsubstituted heteroaryl such as, for example, indole, thiophene, imidazole, oxazole, thiazole, pyrazole, pyridine, pyrimidine, quinoline, isoquinoline, quinazoline, quinoxaline, and purine.

In some of any of the embodiments described herein, at least a portion (e.g., at least two, or at least three, or at least four, or at least five) or all, of the amino acid residues in the peptide are each independently an aromatic amino acid residue, as described herein.

In some of any of the embodiments described herein, the aromatic peptide is a di-peptide or a tri-peptide, namely, it is an aromatic peptide of two or three amino acid residues, respectively, in which two of the amino acid residues are each independently an aromatic amino acid residue.

In some of any of the embodiments described herein, the aromatic peptide is a tri-peptide, namely, it is an aromatic peptide of three amino acid residues, respectively, in which at least two, or all, of the amino acid residues are each independently an aromatic amino acid residue.

In some of any of the embodiments described herein, the aromatic peptide is a tri-peptide, namely, it is an aromatic peptide of three amino acid residues, respectively, in which all of the amino acid residues are each independently an aromatic amino acid residue.

In some of any of the embodiments described herein, each of the aromatic amino acid residues is independently selected from phenylalanine and tyrosine residues and analogs thereof, as described herein.

In some of any of the embodiments described herein, in at least a portion, or in all, of the aromatic peptides, at least 50%, or at least 60%, or at least 70%, or at least 80%, or at least 90%, of the aromatic amino acid residues are selected from tyrosine residues and analogs thereof, preferably tyrosine residues.

In some of any of the embodiments described herein, the aromatic peptide is selected from FY, YF, YY, FFY, YFF, FYY, YFY, YYF and YYY.

In some of any of the embodiments described herein, the aromatic peptide is selected from FY, YF, YY, FYY, YFY, YYF and YYY.

In exemplary embodiments, the aromatic peptide is YYY.

In some of any of the embodiments described herein, the aromatic peptide consists essentially of tyrosine residues and/or analogs thereof, as described herein.

According to some of any of the embodiments described herein, the composition comprises a plurality of peptides, at least a portion, or all, of the peptides are aromatic peptides as described herein in any of the respective embodiments.

In some embodiments, in at least a portion, or all, of the peptides in the plurality of peptides each peptides is independently an aromatic di-peptide or an aromatic tri-peptide, as described herein in any of the respective embodiments.

In some embodiments, each peptide in the plurality of peptides is an aromatic di-peptide or tri-peptide, as described herein in any of the respective embodiments.

Herein, an aromatic di-peptide or tri-peptide describes a peptide composed of two or three amino acid residues, as described herein, wherein at least two of these amino acid residues is an aromatic amino acid residue, as described herein.

The aromatic di-peptides or tri-peptides according to any of these embodiments can be the same or different (e.g., the portion, or all, of the plurality of peptides comprises two or more types of different aromatic dipeptides). When the aromatic di-peptides or tri-peptides are different, they can differ from one another by the type and/or number and/or sequence of the two or more aromatic amino acid residues.

According to some of any of the embodiments described herein, the aromatic di-peptides or tri-peptides in the plurality of peptides are the same, and in some embodiments, all the peptides in the plurality of peptides are the same aromatic di-peptides or aromatic tri-peptides. In exemplary embodiments, all the peptides in the plurality of peptides are the same aromatic tri-peptides.

In some of any of the embodiments of the present invention, at least a portion, or all, of the peptides in the plurality of peptides include aromatic di-peptide or tri-peptides, comprising two aromatic amino acid residues. In some embodiments, each peptide in the plurality of peptides is an aromatic tripeptide, comprising three aromatic amino acid residues.

Thus, the peptides in the (e.g., aqueous) composition can be di-peptides or tri-peptides, composed of two or more aromatic amino acid residues.

Preferably, the composition comprises a plurality of peptides wherein at least 50%, or at least 60%, or at least 70%, or at least 80%, or at least 90%, or all, of the peptides are aromatic tri-peptides that comprise at least one tyrosine residue or an analogue thereof, as described herein.

In some embodiments, the plurality of aromatic tri-peptides comprises a plurality of tri-tyrosine peptides. In some embodiments, the plurality of aromatic tri-peptides consists essentially of tri-tyrosine peptides (Tyr-Tyr-Tyr, or YYY, tri-peptides).

According to some of any of the embodiments described herein, some or all of the aromatic peptides in the plurality of peptides are end-capping modified peptides, in which the N-terminus and/or C-terminus are modified by an end-capping moiety, and are also referred to herein as “end-capping modified aromatic peptides”.

The phrase “end-capping modified aromatic peptide”, as used herein, refers to an aromatic peptide as described herein in any of the respective embodiments which has been modified at the N-(amine)terminus and/or at the C-(carboxyl)terminus thereof.

The end-capping modification refers to the attachment of a chemical moiety to the terminus, so as to form a cap. Such a chemical moiety is referred to herein as an end-capping moiety and is typically also referred to herein and in the art, interchangeably, as a peptide protecting moiety or group.

The phrase “end-capping moiety”, as used herein, refers to a moiety that when attached to the terminus of the peptide, modifies the end-capping. The end-capping modification typically results in masking the charge of the peptide terminus, and/or altering chemical features thereof, such as, hydrophobicity, hydrophilicity, reactivity, solubility and the like. Examples of moieties suitable for peptide end-capping modification can be found, for example, in Green et al., “Protective Groups in Organic Chemistry”, (Wiley, 2nd ed. 1991) and Harrison et al., “Compendium of Synthetic Organic Methods”, Vols. 1-8 (John Wiley and Sons, 1971-1996).

Representative examples of N-terminus end-capping moieties include, but are not limited to, formyl, acetyl (also denoted herein as “Ac”), trifluoroacetyl, benzyl, benzyloxycarbonyl (also denoted herein as “Cbz”), tert-butoxycarbonyl (also denoted herein as “Boc”), trimethylsilyl (also denoted “TMS”), 2-trimethylsilyl-ethanesulfonyl (also denoted “SES”), trityl and substituted trityl groups, allyloxycarbonyl, 9-fluorenylmethyloxycarbonyl (also denoted herein as “Fmoc”), and nitro-veratryloxycarbonyl (“NVOC”).

Representative examples of C-terminus end-capping moieties are typically moieties that lead to acylation of the carboxy group at the C-terminus and include, but are not limited to, benzyl and trityl ethers as well as alkyl ethers, tetrahydropyranyl ethers, trialkylsilyl ethers, allyl ethers, monomethoxytrityl and dimethoxytrityl. Alternatively the —COOH group of the C-terminus end-capping may be modified to an amide group.

Other end-capping modifications of peptides include replacement of the amine and/or carboxyl with a different moiety, such as hydroxyl, thiol, halide, alkyl, aryl, alkoxy, aryloxy and the like, as these terms are defined herein.

End-capping moieties can be classified by their aromaticity. Thus, end-capping moieties can be aromatic or non-aromatic.

Representative examples of non-aromatic end capping moieties suitable for N-terminus modification include, without limitation, formyl, acetyl trifluoroacetyl, tert-butoxycarbonyl, trimethylsilyl, and 2-trimethylsilyl-ethanesulfonyl. Representative examples of non-aromatic end capping moieties suitable for C-terminus modification include, without limitation, amides, allyloxycarbonyl, trialkylsilyl ethers and allyl ethers.

Representative examples of aromatic end capping moieties include, without limitation, fluorenylmethyloxycarbonyl (Fmoc), benzyl, benzyloxycarbonyl (Cbz), trityl and substituted trityl groups.

According to some of any of the embodiments described herein, the aromatic peptides are not end-capping modified aromatic peptides, that is, the peptides feature an amine group at the N-terminus and a carboxylic acid at the C-terminus.

Herein, an analog of an indicated amino acid residue encompasses an end-capping modified amino acid residue, as described herein, in cases where the amino acid analog is a terminal residue in the peptide (is at the N-terminus or C-terminus of the peptide). An analog of an indicated amino acid residue can alternatively or in addition include a derivative of the indicated amino acid residue, for example, an amino acid residue in which the aromatic moiety is substituted by one or more substituents as described herein, and/or in which one or more of the amine or carboxy groups are derivatized by a substituent or replaced by another group.

For example, an analog of a phenylalanine residue can be a halogenated phenylalanine residue, in which the phenyl group is substituted by one or more halo substituents. Another analog of a phenylalanine residue can be such that the phenyl group is replaced by a substituted or unsubstituted naphthalene or any other all-carbon aromatic moiety (aryl) or a heteroaryl, as described and/or defined herein. An analog of an aromatic amino acid residue can include any of the aromatic moieties as described herein, which are other than the phenyl, phenol and indole moieties present in the Phe, Tyr and Trp, respectively.

In some of any of the embodiments described herein, tyrosine residues and analogs thereof, as described herein, can be collectively represented by Formula I:

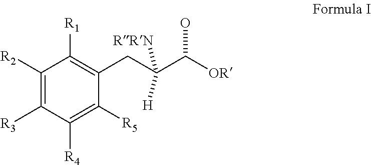

wherein:
the dashed lines represent D- or L-configuration of the amino acid residue;
each of R₁—R₅ is independently selected from hydrogen, hydroxy, alkoxy, alkyl, cycloalkyl, halo, thiol, thioalkyl, amine, carboxylate, thiocarboxylates and any other substituent, provided that at least one of R₁—R₅ is hydroxy; and
each of R′, R″ and R′″ is independently selected from hydrogen, alkyl, cycloalkyl, aryl and any other substituent that can form an end-capping moiety as described herein.

According to some of any of the embodiments related to Formula I, one or more, or each of R′, R″ and R′″ is hydrogen.

According to some of any of the embodiments related to Formula I, or each of R′, R″ and R′″ is hydrogen, such that the tyrosine or the analog thereof are not end-capping modified.

According to some of any of the embodiments related to Formula I, R₃ is hydroxy. Alternatively, or in addition, R₁, R₂, R₄ and/or R₅ is hydroxy.

In some embodiments, two or more of R₁—R₅ are each hydroxy. An exemplary such a tyrosine analog is also referred to in the art as DOPA.

It is to be noted that Formula I describes a tyrosine residue or an analog thereof per se, that is, before it forms a part of the aromatic peptide as described herein.

When a tyrosine residue or an analog thereof that is represented by Formula I is at the N-terminus of the peptide, it can be represented by Formula Ia:

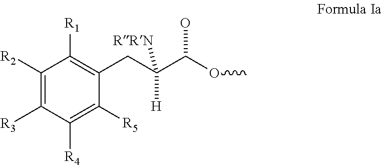

wherein:
the curved line represents the attachment point to the following residue in the sequence; and
the dashed lines and each of R₁—R₅, R′ and R″ are as described herein for Formula I.

When a tyrosine residue or an analog thereof that is represented by Formula I is at the C-terminus of the peptide, it can be represented by Formula Ib:

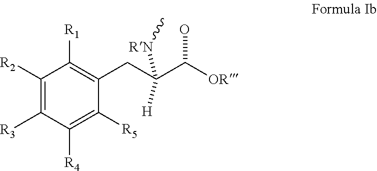

wherein:
the curved line represents the attachment point to the PRECEDING residue in the sequence; and
the dashed lines and each of R₁—R₅, R′ and R′″ are as described herein for Formula I.

When a tyrosine residue or an analog thereof that is represented by Formula I is at a non-terminal residue the peptide, it can be represented by Formula Ic:

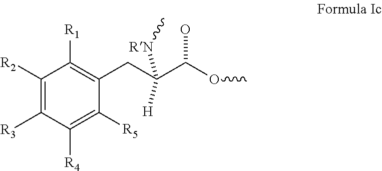

wherein:
the curved lines represent the attachment points to the neighboring residues in the sequence; and
the dashed lines and each of R₁—R₅ and R′ are as described herein for Formula I. In some of any of the embodiments described herein, the solvent is an aqueous solvent which is or comprises water. In some embodiments, the composition is an aqueous composition, and in some embodiments the composition is an aqueous solution.

For any of Formulae I, Ia, Ib and Ic, the dashed lines typically represent an L configuration, such that in Formula I, for example, the configuration is:

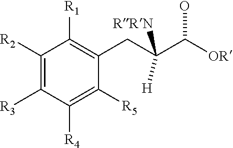

The same configuration can be applied to Formula Ia, Ib and/or Ic.

In some of any of the embodiments described herein, the aqueous solvent comprises or consists of water. In some of any of the embodiments described herein, the aqueous solvent comprises water and optionally water-soluble components (other than the plurality of peptides), for example, water-soluble salts. In exemplary embodiments the aqueous solvent is a buffer (e.g., featuring pH of from 6 to 8). In exemplary embodiments the aqueous solvent consists of water.

In some of any of the embodiments described herein, the concentration of each peptide in the plurality of peptides in the composition ranges from 0.1 to 100%, or from 1 to 100%, or from 10 to 99%, or from 30 to 95%, of its solubility in the solvent. That is, for example, if the solubility of a peptide in the solvent (e.g., water) is 100 mg/ml (at 25° C.), the concentration of the peptide can range from 0.1 to 100 mg/ml.

In some of any of the embodiments described herein, the composition is an aqueous solution, which comprises an aqueous solvent and a water-soluble peptide, and the concentration of each peptide in the plurality of peptides in the composition ranges from 0.1 to 100%, or from 10 to 99%, or from 30 to 95%, of its solubility in water at 25° C. That is, for example, if the solubility of a peptide in water is 100 mg/ml (at 25° C.), the concentration of the peptide can range from 0.1 to 100 mg/ml. Alternatively, if the solubility of a peptide in water is 10 grams/100 grams, or 10% by weight (at 25° C.), the concentration of the peptide can range from 1% to 10% by weight.

In some of any of the embodiments described herein, at least some, or all, of the peptides (each independently) feature a solubility of at least 100 mg/ml, or at least 200 mg/ml, or at least 500 mg/ml or at least 1,000 mg/ml, or higher, at 25° C., in the solvent.

In some of any of the embodiments described herein, at least some, or all, of the peptides (each independently) feature a solubility of at least 100 mg/ml, or at least 200 mg/ml, or at least 500 mg/ml or at least 1,000 mg/ml, or higher, at 25° C., in water.

In some of any of the embodiments described herein, the composition is an aqueous solution and at least some or all of the peptides (each independently) feature a solubility of at least 100 mg/ml, or at least 200 mg/ml, or at least 500 mg/ml or at least 1,000 mg/ml, or higher, at 25° C., in water.

In some of any of the embodiments described herein, the composition is capable of forming a rigid and/or non-crystalline material upon evaporation of the solvent, as described herein in any of the respective embodiments and any combination thereof.

In some of any of the embodiments described herein, the composition is capable of forming an adhesive material upon evaporation of the solvent, as described herein in any of the respective embodiments and any combination thereof, and is an adhesive composition.

The material:

According to an aspect of some embodiments of the present invention there is provided a material comprising a plurality of peptides as defined in any of the embodiments herein, assembled into a non-crystalline structure. Such a material is also referred to herein as a non-crystalline peptide material or simply as a peptide material or as a rigid, non-crystalline material or as a rigid non-crystalline peptide material.

According to some of any of the embodiments described herein, the material is formed of the composition that comprises a plurality of peptides and a solvent as described herein in any of the respective embodiments and any combination thereof, upon (e.g., partial) evaporation of the solvent.

The term “non-crystalline” encompasses the term “amorphous” as this term is known and determined in the art, and describes a material that lacks regular, repeating atomic or molecular structure, and features a disorders structure.

Crystallinity and non-crystallinity of a material can be determined using methodologies well-known in the art, for example, by XRD measurements.

In some of any of the embodiments described herein, the material is a transparent material.

The term “transparent” describes a property of a hardened material that reflects the transmittance of light therethrough. A transparent material is typically characterized as capable of transmitting at least 70% of a light (e.g., visible light) that passes therethrough, or by transmittance of at least 70% of the light.

Transparency of a material can be measured by methods well known in the art. An exemplary method is described in the Examples section that follows. Transparency typically refers to visible light, unless otherwise indicated.

According to some of any of the embodiments described herein, the material is formed of a composition as described herein in any of the respective embodiments and any combination thereof, upon evaporation of the solvent, or once the solvent evaporates, as described herein in any of the respective embodiments and any combination thereof.

According to some of any of the embodiments described herein, the material is formed of an aqueous composition (e.g., an aqueous solution) as described herein in any of the respective embodiments and any combination thereof, upon evaporation of the aqueous solvent (e.g., water), or once the solvent evaporates, as described herein in any of the respective embodiments and any combination thereof.

According to some of the any of the embodiments described herein, the evaporation of the solvent is partial, that is, is such that at least a portion of the solvent that is in the composition remains and forms a part of the non-crystalline material. This portion of the solvent can be from 1 to 80, or from 1 to 50, or from 1 to 30, or from 1 to 20, or from 1 to 10, or from 1 to 5, % by weight, of the solvent.

The evaporation of the solvent can be spontaneous, namely, at ambient atmosphere (temperature and pressure), typically during a time period that ranges from several minutes to 1 to several hours, or longer (e.g., one or more days), or can be effected at elevated temperature, e.g., a temperature of 30° C. or higher, e.g., of up to the boiling temperature of the solvent or even higher, typically during a shorter time period (e.g., of up to 2 hours, or up to one hour), at atmospheric pressure or reduced pressure, or can be effected at ambient temperature but under reduced pressure, typically during a shorter time period (e.g., of up to 2 hours, or up to one hour).

Thus, the phrases “once the solvent evaporates” and “upon evaporation of the solvent” describe interchangeably a removal of at least a portion of the solvent, as described herein, which can be effected spontaneously or actively, by subjecting the composition to conditions that promote removal of the solvent.

It is to be noted that the evaporation rate and conditions (e.g., time and temperature) can affect the properties of the material, as it may determine the mol ratio between the peptides and the solvent molecules, as is discussed in further detail hereinunder, and can be selected accordingly.

According to some of any of the embodiments described herein, the assembled non-crystalline structure forming the material further comprises molecules of the solvent (e.g., water) associated with at least a portion of the peptides. The solvent molecules are associated with the peptides via non-covalent interactions, such as hydrogen bonds and/or Van-der-Waals bonds, preferably forming non-covalent cross-linking of the peptides. In some of the embodiments in which the solvent is or comprises water, the water molecules are associated with the plurality of peptides mostly via hydrogen bonds, for example, via hydrogen bond (intermolecular) crosslinking.

The plurality of peptides in the assembled non-crystalline structure may be associated to one another via intermolecular covalent and/or non-covalent bonds. Non-covalent bonds are typically hydrogen bonds and/or aromatic interactions (π-π stacking). Covalent bonds can be formed when the material is subjected to conditions that promote covalent cross-linking of the peptides to one another, either before, during or after the evaporation of the solvent. Such conditions include, for example, application of heat and/or irradiation (e.g., UV irradiation), optionally in the presence of a catalyst (e.g., hydrogen peroxide).

It is to be noted that in cases where the a portion or all of the peptides are associated with one another via covalent bonds as described herein, the association with the solvent molecules are via non-covalent bonds, as described herein. Preferably, at least some of the peptides are associated to one another via non-covalent bonds as described herein.

As discussed hereinabove, the content of the solvent molecules in the non-crystalline peptide material typically affects the properties of the material, and can be determined, manipulated or controlled in accordance with the evaporation conditions during the formation of the material. The material can comprise solvent molecules at a mol ratio to the peptides that ranges from 1:1 to 50:1, or from 1:1 to 30:1, or from 1:1 to 20:1 or from 1:1 to 15:1, including any intermediate values and subranges therebetween. Higher (e.g., up to 100:1) and lower (e.g., lower than 1:1) mol ratio values are also contemplated.

As discussed herein in further detail hereinunder, when the solvent is or comprises water, and the non-crystalline peptide material comprises water molecules, the water content (e.g., in terms of the mol ratio to the peptides) is reversible, and can be manipulated in accordance with the water content in the environment of the material (e.g., the relative humidity).

According to some of any of the embodiments described herein, the non-crystalline peptide material is a glassy material.

As is well-known in the art, a glassy material is a non-crystalline material, which is typically transparent, and which features properties of a glass, such as gradually softening over a temperature range (“glass transition temperature” or “Tg”), and brittleness, hardness and elastic modulus (e.g., reduced elastic modulus) similar to those of a glass.

Herein, “Tg” of a material refers to glass transition temperature defined as the half-height of the step in the heat flow trace as a function of the temperature. Tg can be measured by methods well known in the art, typically using DSC measurements, as exemplified in the Examples section that follows.

Herein and in the art “hardness” of a glassy material refers to Vickers hardness (HV), which is expressed in pascals (MPa), and is a measure of a material's resistance to localized deformation or indentation, whereas pressure is a measure of force applied over an area. The formula for Vickers hardness is: HV═2P/A, wherein P is the applied force in Newtons (N) and A is the surface area of the indentation in square meters. An exemplary protocol for measuring the hardness of a material as described herein is described in the Examples section that follows. Hardness of glass typically ranges from 480 to 600 MPa.

Herein “reduced modulus of elasticity” or “Er” of a glassy material describes the elastic response of a material to an indenter and is a combination of both the elastic properties of the material and the geometry of the indentation. It relates to the modulus of elasticity of the material (E), the Poisson's ratio (v) and the indenter's geometry. Er can be determined, for a spherical indenter, using the following equation: Er=E/2(1-v²). Er of glass typically ranges from 70 to 90 GPa and Er of polymeric glassy materials is typically lower, around 10-15 GPa. An exemplary protocol for measuring the reduced modulus of elasticity of a material as described herein is described in the Examples section that follows.

According to some of any of the embodiments described herein, the non-crystalline peptide material features Tg higher than room temperature, or higher than 30° C.

As exemplified in the Examples section that follows, and discussed hereinabove, according to some embodiments, at least some of the physical and/or mechanical properties of a non-crystalline peptide material as described herein are dictated by the content (e.g., mol ratio) of the solvent molecules and the peptides. When the solvent is or comprises water and the non-crystalline peptide material comprises water molecules associated with the peptides as described herein, the water content in the material can correlate to the relative humidity in the environment that surrounds the material.

By “relative humidity” or “RH” it is meant the amount of water vapor present in the air compared to the maximum amount that the air can hold at a specific temperature. The relative humidity is expressed as a percentage and is calculated by the following formula:

RH (%)=(actual water vapor pressure/saturated water vapor temperature at the same temperature)×100

Herein, unless indicated otherwise, RH relates to room temperature.

According to some of any of the embodiments described herein, when a mol ratio of the solvent (e.g., water molecules) and the peptides in the material is higher than 5:1 or higher than 10:1, and is, for example, in a range of from 10:1 to 50:1, or from 10:1 to 30:1 or from 10:1 to 20:1, including any intermediate values and subranges therebetween, the material is characterized by Tg lower than 100° C., or lower than 80, or lower than 70, or lower than 60, or lower than 50, ° C., from example, Tg that ranges from room temperature to about 100° C., or from about 30 to about 100, or from about 30 to about 80, or from about 30 to about 70, or from about 30 to about 60, or from about 30 to about 50, ° C., including any intermediate values and subranges therebetween. According to some of these embodiments, a material featuring such a mol ratio of the solvent and the peptides features hardness that is lower by at least 10%, typically by at least 20%, or at least 30%, or at least 50% or even more, of a hardness of a respective material that features a lower mol ratio of water to peptides, as described herein. In exemplary non-limiting embodiments, a material featuring such a mol ratio of the solvent and the peptides features hardness as defined herein which is lower than 500 MPa, or lower than 400 MPa, or lower than 300 MPa or lower than 200 MPa, or, for example, hardness as defined herein that ranges from 10 to 500, or from 10 to 400, or from 10 to 300, or from 10 to 200, or from 50 to 500, or from 50 to 400, or from 50 to 200, or from 50 to 200, or from 50 to 150, MPa, including any intermediate values and subranges therebetween. In some embodiments, a material featuring such a mol ratio of the solvent and the peptides features hardness similar to that of a polymeric glassy material.

According to some of any of the embodiments described herein, a mol ratio of the solvent (e.g., water molecules) and the peptides in the material is lower than 10:1 or lower than 5:1, and is, for example, in a range of from 10:1 to 1:10, or from 10:1 to 1:5 or from 10:1 to 1:1, or from 5:1 to 1:5 or from 5:1 to 1:1, including any intermediate values and subranges therebetween, the material is characterized by one or more, two or more, or all of the following:

Tg higher than 50° C., or higher than 80, or higher than 80, or higher than 100° C., from example, Tg that ranges from about 100° C. to about 150° C., or from about 80 to about 150, or from about 100 to about 150, or from about 100 to about 130, or from about 100 to about 120, or from about 80 to about 120, ° C., including any intermediate values and subranges therebetween;

Hardness, as defined herein, that ranges from about 400 to about 1,000 MPa, or from about 400 to about 800 MPa, or from about 500 to about 800 MPa, or from about 600 to about 800 MPa, including any intermediate values and subranges therebetween; and

Reduced modulus of elasticity that ranges from 1 to 20 GPa, or from 5 to 20, or from 5 to 15, or from 10 to 20, or from 10 to 15, GPa, including any intermediate values and subranges therebetween.

According to some of any of the embodiments described herein, the non-crystalline peptide material features Tg lower than 100, or lower than 50, ° C., or in a range of from room temperature to 100, or from 30 to 100, ° C., as described herein, and/or a hardness, as defined herein, lower than 500 or lower than 400 or lower than 300 or lower than 200, MPa, when the relative humidity of the environment around it is at least 50%, or at least 60%, or at least 70%.

Without being bound by any particular theory, it is assumed that water molecules in such an environment interact with the material and affect its water content, such that a mol ratio of the water molecules and the peptides in the material are such that provide the indicated Tg and/or hardness.

According to some of any of the embodiments described herein, the non-crystalline peptide material features one or more, two or more, or all of the following features:

Tg higher than 50° C., or higher than 80, or higher than 80, or higher than 100° C., from example, Tg that ranges from about 100° C. to about 150° C., or from about 80 to about 150, or from about 100 to about 1500, or from about 100 to about 1300, or from about 100 to about 120, or from about 80 to about 120, ° C., including any intermediate values and subranges therebetween;

Hardness, as defined herein, that ranges from about 400 to about 1,000 MPa, or from about 400 to about 800 MPa, or from about 500 to about 800 MPa, or from about 600 to about 800 MPa, including any intermediate values and subranges therebetween; and Reduced modulus of elasticity that ranges from 1 to 20 GPa, or from 5 to 20, or from 5 to 15, or from 10 to 20, or from 10 to 15, GPa, including any intermediate values and subranges therebetween, when the relative humidity of the environment around it is lower than 50%, or lower than 40%, or lower than 30%, or lower than 20%.

Without being bound by any particular theory, it is assumed in such an environment, a mol ratio of the water molecules and the peptides in the material does not change, since an association of water molecules from the air with the peptides in the material is less likely to occur.

According to some of any of the embodiments described herein, the physical and mechanical properties of the non-crystalline peptide material can be controlled by controlling the water content in the material, which in turn can be controlled by the evaporation extent during its preparation and/or by the water content of the surrounding environment (the relative humidity).

According to some of any of the embodiments described herein, the physical and mechanical properties of the non-crystalline peptide material can be controlled by the water content of the surrounding environment (the relative humidity) and are reversible. Thus, when the material is such that the water content therein is relatively low (e.g., a mol ratio of water to peptide lower than 5:1) or even null, and it features properties as described herein for such a material, these properties can be manipulated by contacting the material with a humid environment (e.g., RH higher than 50% as described herein, such that material features properties as described herein for a higher water content (e.g., mol ratio water to peptides of at least 10:1). The material can then be “dehydrated” again by letting the water evaporate, e.g., as described herein.

According to some of any of the embodiments described herein, when the water content of the material is low or null, the material features high brittleness (it tends to fracture or crack without significant deformation); and when the water content in the material is higher, as described herein, it is less brittle and more ductile and deformable.

The reversibility of the properties of the material as a result of the water content therein provides the material with a self-healing properties, such that when cracks or fractures are formed in a dehydrated material, in which the content of water molecules is low or null, contacting the material with a water-saturated environment, for example, an environment featuring RH of at least 60 or at least 70%, results in increase of the water content in the material and the cracks or fractures are healed.

According to some of any of the embodiments described herein, the non-crystalline peptide material is a self-healing glassy material, capable of diminishing cracks formed therein. Diminishing the cracks as be effected by exposure of the cracked material to an environment that features a relative humidity higher than 50% as described herein, or otherwise increasing the water content in the material.

According to an aspect of some embodiments of the present invention there is provided a self-healing glassy material, for example, a self-healing glassy material featuring properties as described herein in any of the respective embodiments. According to some of these embodiments, the self-healing glassy material comprises or consists of peptides and optionally water, and is therefore biodegradable, self-healing, glassy material.

According to an aspect of some embodiments of the present invention there is provided a biodegradable glassy material.

According to an aspect of some embodiments of the present invention there is provided a recyclable, optionally biodegradable, optionally self-healing, glassy material.

According to an aspect of some embodiments of the present invention there is provided a self-healing glassy material, which is capable of diminishing cracks or fractures formed therein. According to some embodiments, such a glassy material comprises water molecules that impart non-covalent intermolecular cross-linking of the components that form the glassy material. According to some embodiments, such a material is capable of reversibly converting from a dehydrated to a hydrated form thereof to thereby diminish cracks or fractures, by contacting the material with a water-containing environment (e.g., a humid environment). According to some embodiments, such a material is capable of reversibly converting from a brittle state (typically featuring relatively high Tg and hardness and elastic modulus) to a ductile, deformable, state (typically featuring lower Tg and hardness and elastic modulus), by contacting the material with a water-containing environment (e.g., a humid environment).

According to some of any of these embodiments, the glassy material is as described herein for any of the respective embodiments that relate to non-crystalline peptide material.

Additional properties of the non-crystalline peptide material as described herein, include capability of increasing the transparency of a substrate onto which it is deposited or to which it is adhered, or when interposed between two substrates by, for example, at least 5%, or at least 10%, for both visible light and IR light; maintaining the refractive index of such a substrate or two substrates (e.g., such that the refractive index remains substantially the same (±10% or ±5%) in its presence on the substrate or between two substrates); and adhesiveness.

According to some of any of the embodiments described herein, the non-crystalline peptide material as described herein is an adhesive material, which is capable of adhering to a substrate and/or of adhering two substrates to one another.

According to some of any of the embodiments described herein, when the adhesive material is deposited between the surfaces or portions thereof of two substrates, it is characterized by a cohesive strength in a range of from 200 to 800, or from 250 to 600, or from 300 to 500 kilopascal (kPa). A cohesive strength can be measured as described in the Examples section that follows.

According to some of any of the embodiments described herein, the cohesive strength is maintained at a temperature in the range of from −200 to 200° C., indicating a thermal stability of the material as described herein.

Applications:

According to an aspect of some embodiments of the present invention there is provided a method of forming a layer of a rigid, non-crystalline, peptide material on a surface of a substrate. The peptide material is as described herein in any of the respective embodiments and any combination thereof, and can be a glassy material and/or an adhesive material, featuring properties as described herein in any of the respective embodiments. According to these embodiments, the method is effected by applying or depositing to the surface of the substrate or a portion thereof, or contacting the surface of the substrate or a portion thereof with, the composition (e.g., aqueous composition or solution) as described herein in any of the respective embodiments and any combination thereof. The contacting of the composition with the surface of the substrate or the portion thereof results in the formation of a layer of the material, once the solvent evaporates. The solvent can evaporate spontaneously, while maintaining the substrate having the composition applied thereon at ambient conditions, or by any other means as described herein with respect to preparing the non-crystalline peptide material.

According to an aspect of some embodiments of the present invention there is provided a method of forming a layer of an adhesive material on a surface of a substrate, the method comprising applying the adhesive composition of any of the embodiments herein, on the surface of the substrate to thereby form a layer of the adhesive material on the surface of the substrate.

In some of any of the embodiments described herein, the solvent evaporates at a temperature in a range of from room temperature (e.g., 25° C.) to a boiling temperature of the solvent (e.g., 100° C.), although higher temperatures are also contemplated.

In some of any of the embodiments described herein, the adhesive material is a non-crystalline material as defined in any of the embodiments herein.

In some of any of the embodiments described herein, the rigid non-crystalline material is capable of increasing a light transmittance of the substrate (e.g., by 5%, or by 10%, or by 15%, higher light transmittance of the substrate compared to the light transmittance of the substrate without the layer of the adhesive material formed on the surface thereof).

In some of any of the embodiments described herein, the substrate is or comprises glass and/or plastic.

In some of any of the embodiments described herein, the substrate comprises a material selected from glass, metal, carbon, wood, cardboard, paper, fibers, synthetic fibers, polymers, biopolymers, composite materials and biological tissues, and any combination thereof.

In some of any of the embodiments described herein, the substrate is a hydrophilic substrate as described herein.

According to an aspect of some embodiments of the present invention there is provided a substrate having applied on at least a portion of a surface thereof the non-crystalline peptide material as described herein in any of the respective embodiments and any combination thereof.

According to some of these embodiments, the substrate is obtainable by the respective method as described herein in any of the respective embodiments and any combination thereof.

According to some of these embodiments, the substrate is a hydrophilic substrate such as a glass. Alternatively, the substrate is a hydrophobic substrate as described herein.

According to an aspect of some embodiments of the present invention there is provided a method of adhering at least two substrates to one another, the method comprising contacting the at least two substrates (e.g., a surface or a portion thereof of each substrate) with the composition (e.g., aqueous composition or solution) as described herein in any of the respective embodiments and any combination thereof.

According to some of these embodiments, the two substrates are adhered to one another once the solvent evaporates, as described herein.

According to some of these embodiments, the method can be effected by contacting the two substrates or portions thereof with a composition as described herein, followed by evaporation of the solvent (e.g., spontaneous evaporation) as described herein. According to some of these embodiments, the substrates are hydrophobic substrates as described herein. According to some of these embodiments, the substrates are hydrophilic substrates as described herein.

According to some of these embodiments, the method can be effected by contacting a surface or a portion thereof of one of the substrates with the composition, forming a layer of a non-crystalline material on the surface or a portion thereof once the solvent evaporates, as described herein, to thereby form an adhesive layer on the surface, and then contacting the substrate having an adhesive layer thereon with the other substrate. According to some of these embodiments, the substrates are hydrophilic substrates as described herein.

According to an aspect of some embodiments of the present invention there is provided an article-of-manufacturing comprising at least two substrates, as defined in any of the embodiments described herein, and an adhesive material as defined in any of the embodiments described herein, being in contact with at least a portion of a surface of each of the at least two substrates.

According to an aspect of some embodiments of the present invention there is provided an article-of-manufacturing comprising the non-crystalline peptide material as described in any of the respective embodiments and any combination thereof.

In some embodiments of this aspect of the present invention, the article-of-manufacturing or a respective portion or component thereof is prepared by contacting a hydrophobic substrate, optionally shaped as the article or the portion or component thereof, with a composition as described herein. Once the solvent evaporates, a non-crystalline peptide material is formed, and can be detached from the hydrophobic substrate, to thereby provide the article or the portion or component thereof.

An exemplary article-of-manufacturing of is or comprises an optical lens.

Exemplary articles-of-manufacturing according to any of the respective embodiments include, but are not limited to, articles that comprise a glassy material or an otherwise transparent material.

Exemplary articles-of-manufacturing according to any of the respective embodiments include, but are not limited to, an optical component or system, a textile product, a packaging, a transportation vehicle, a component of an agricultural machinery and equipment, an aerospace system or vehicle, a construction component, an electronic product (component or system), a personal care product, an agricultural product, a cleaning product, a biomedical product, a houseware product, a laboratory equipment, and an antimicrobial product.

Herein throughout, a hydrophilic substrate is a substrate that has a relatively high affinity to water, and can attract, absorb or otherwise interact with water molecules. A substrate can be hydrophilic by being made of a hydrophilic substance or by being coated by a hydrophilic substance, such that its surface or a portion thereof comprises a hydrophilic substance. Exemplary hydrophilic substances include, but are not limited to, glass, cellulose-based materials such as wood, paper and textiles, polymeric materials such as polyvinyl alcohol (PVA) and other water-soluble polymers, poly(alkylene glycols) such as PEG, polyacrylamides, polyurethanes, polyethylene oxides, hydrogels, silica-based materials such as silica gel, certain metallic substances such as aluminum oxide or otherwise treated or coated metals, ceramics, Nylons, chitosan and biological surfaces.

Herein throughout, a hydrophobic substrate is a substrate that has a relatively low affinity to water, and which typically repels water molecules. A substrate can be hydrophobic by being made of a hydrophobic substance or by being coated by a hydrophobic substance, such that its surface or a portion thereof comprises a hydrophobic substance. Exemplary hydrophobic substances include, but are not limited to, polytetrafluoroethylene (PTFE or Teflon), polyolefins such as polyethylene and polypropylene, silicon-based materials such as silicone oil, PDMS, and the like, fluorinated polymers such as fluorinated rubbery polymers, was and other hydrocarbon solid substances, certain metal oxides, such as zinc oxide, solid oils, plastics, naturally-occurring water-repellent substances such as insect wings, shark skin, etc., water-repellent fabrics, and more.

Herein, the term “peptide” refers to a polymer comprising at least 2 amino acid residues linked by peptide bonds or analogs thereof (as described herein below), and optionally only by peptide bonds per se.

The term “peptide” encompasses native peptides (e.g., degradation products, synthetically synthesized peptides and/or recombinant peptides), including, without limitation, native proteins, fragments of native proteins and homologs of native proteins and/or fragments thereof; as well as peptidomimetics (typically, synthetically synthesized peptides) and peptoids and semipeptoids which are peptide analogs, which may have, for example, modifications rendering the peptides more stable while in a body or more capable of penetrating into cells. Such modifications include, but are not limited to N-terminus modification, C-terminus modification, peptide bond modification, backbone modifications, and residue modification. Methods for preparing peptidomimetic compounds are well known in the art and are specified, for example, in Quantitative Drug Design, C. A. Ramsden Gd., Chapter 17.2, F. Choplin Pergamon Press (1992), which is incorporated by reference as if fully set forth herein. Further details in this respect are provided herein below.

Peptide bonds (—CO—NH—) within the peptide may be substituted, for example, by N-methylated amide bonds (—N(CH₃)—CO—), ester bonds (—C(═O)—O—), ketomethylene bonds (—CO—CH₂—), sulfinylmethylene bonds (—S(═O)—CH2-), α-aza bonds (—NH—N(R)—CO—), wherein R is any alkyl (e.g., methyl), amine bonds (—CH₂—NH—), sulfide bonds (—CH₂—S—), ethylene bonds (—CH₂—CH₂—), hydroxyethylene bonds (—CH(OH)—CH₂—), thioamide bonds (—CS—NH—), olefinic double bonds (—CH═CH—), fluorinated olefinic double bonds (—CF═CH—), retro amide bonds (—NH—CO—), peptide derivatives (—N(R)—CH₂—CO—), wherein R is the “normal” side chain, naturally present on the carbon atom.

These modifications can occur at any of the bonds along the peptide chain and even at several (2-3) bonds at the same time.

Natural aromatic amino acids, Trp, Tyr and Phe, may be substituted by non-natural aromatic amino acids such as 1,2,3,4-tetrahydroisoquinoline-3-carboxylic acid (Tic), naphthylalanine, ring-methylated derivatives of Phe, halogenated derivatives of Phe or O-methyl-Tyr.

The peptides of some embodiments of the invention may also include one or more modified amino acids or one or more non-amino acid monomers (e.g., fatty acids, complex carbohydrates etc.).

The term “amino acid” or “amino acids” is understood to include the 20 naturally occurring amino acids; those amino acids often modified post-translationally in vivo, including, for example, hydroxyproline, phosphoserine and phosphothreonine; and other unusual amino acids including, but not limited to, 2-aminoadipic acid, hydroxylysine, isodesmosine, nor-valine, nor-leucine and ornithine. Furthermore, the term “amino acid” includes both D- and L-amino acids. In some embodiments, an amino acid residue as described herein is an L-amino acid.

Tables A and B below list naturally occurring amino acids (Table A), and non-conventional or modified amino acids (e.g., synthetic, Table B) which can be used with some embodiments of the invention.

TABLE A

| | Three-Letter | One-letter |
|---|---|---|
| Amino Acid | Abbreviation | Symbol |
| Alanine | Ala | A |
| Arginine | Arg | R |
| Asparagine | Asn | N |
| Aspartic acid | Asp | D |
| Cysteine | Cys | C |
| Glutamine | Gln | Q |
| Glutamic Acid | Glu | E |
| Glycine | Gly | G |
| Histidine | His | H |
| Isoleucine | Ile | I |
| Leucine | Leu | L |
| Lysine | Lys | K |
| Methionine | Met | M |
| Phenylalanine | Phe | F |
| Proline | Pro | P |
| Serine | Ser | S |
| Threonine | Thr | T |
| Tryptophan | Trp | W |
| Tyrosine | Tyr | Y |
| Valine | Val | V |
| Any amino acid as above | Xaa | X |

TABLE B

| Non-conventional | | Non-conventional | |
|---|---|---|---|
| amino acid | Code | amino acid | Code |
| ornithine | Orn | hydroxyproline | Hyp |
| α-aminobutyric | Abu | aminonorbornyl- | Norb |
| acid | | carboxylate | |
| D-alanine | Dala | aminocyclopropane- | Cpro |
| | | carboxylate | |
| D-arginine | Darg | N-(3-guanidinopropyl)glycine | Narg |
| D-asparagine | Dasn | N-(carbamylmethyl)glycine | Nasn |
| D-aspartic acid | Dasp | N-(carboxymethyl)glycine | Nasp |
| D-cysteine | Dcys | N-(thiomethyl)glycine | Ncys |
| D-glutamine | Dgln | N-(2-carbamylethyl)glycine | Ngln |
| D-glutamic acid | Dglu | N-(2-carboxyethyl)glycine | Nglu |
| D-histidine | Dhis | N-(imidazolylethyl)glycine | Nhis |
| D-isoleucine | Dile | N-(1-methylpropyl)glycine | Nile |
| D-leucine | Dleu | N-(2-methylpropyl)glycine | Nleu |
| D-lysine | Dlys | N-(4-aminobutyl)glycine | Nlys |
| D-methionine | Dmet | N-(2-methylthioethyl)glycine | Nmet |
| D-ornithine | Dorn | N-(3-aminopropyl)glycine | Norn |
| D-phenylalanine | Dphe | N-benzylglycine | Nphe |
| D-proline | Dpro | N-(hydroxymethyl)glycine | Nser |
| D-serine | Dser | N-(1-hydroxyethyl)glycine | Nthr |
| D-threonine | Dthr | N-(3-indolylethyl) glycine | Nhtrp |
| D-tryptophan | Dtrp | N-(p-hydroxyphenyl)glycine | Ntyr |
| D-tyrosine | Dtyr | N-(1-methylethyl)glycine | Nval |
| D-valine | Dval | N-methylglycine | Nmgly |
| D-N-methylalanine | Dnmala | L-N-methylalanine | Nmala |
| D-N-methylarginine | Dnmarg | L-N-methylarginine | Nmarg |
| D-N-methylasparagine | Dnmasn | L-N-methylasparagine | Nmasn |
| D-N-methylasparatate | Dnmasp | L-N-methylaspartic acid | Nmasp |
| D-N-methylcysteine | Dnmcys | L-N-methylcysteine | Nmcys |
| D-N-methylglutamine | Dnmgln | L-N-methylglutamine | Nmgln |
| D-N-methylglutamate | Dnmglu | L-N-methylglutamic acid | Nmglu |
| D-N-methylhistidine | Dnmhis | L-N-methylhistidine | Nmhis |
| D-N-methylisoleucine | Dnmile | L-N-methylisolleucine | Nmile |
| D-N-methylleucine | Dnmleu | L-N-methylleucine | Nmleu |
| D-N-methyllysine | Dnmlys | L-N-methyllysine | Nmlys |
| D-N-methylmethionine | Dnmmet | L-N-methylmethionine | Nmmet |
| D-N-methylornithine | Dnmorn | L-N-methylornithine | Nmorn |
| D-N-methylphenylalanine | Dnmphe | L-N-methylphenylalanine | Nmphe |
| D-N-methylproline | Dnmpro | L-N-methylproline | Nmpro |
| D-N-methylserine | Dnmser | L-N-methylserine | Nmser |
| D-N-methylthreonine | Dnmthr | L-N-methylthreonine | Nmthr |
| D-N-methyltryptophan | Dnmtrp | L-N-methyltryptophan | Nmtrp |
| D-N-methyltyrosine | Dnmtyr | L-N-methyltyrosine | Nmtyr |
| D-N-methylvaline | Dnmval | L-N-methylvaline | Nmval |
| L-norleucine | Nle | L-N-methylnorleucine | Nmnle |
| L-norvaline | Nva | L-N-methylnorvaline | Nmnva |
| L-ethylglycine | Etg | L-N-methyl-ethylglycine | Nmetg |
| L-t-butylglycine | Tbug | L-N-methyl-t-butylglycine | Nmtbug |
| L-homophenylalanine | Hphe | L-N-methyl-homophenylalanine | Nmhphe |
| α-naphthylalanine | Anap | N-methyl-α-naphthylalanine | Nmanap |
| penicillamine | Pen | N-methylpenicillamine | Nmpen |
| γ-aminobutyric acid | Gabu | N-methyl-γ-aminobutyrate | Nmgabu |
| cyclohexylalanine | Chexa | N-methyl-cyclohexylalanine | Nmchexa |
| cyclopentylalanine | Cpen | N-methyl-cyclopentylalanine | Nmcpen |
| α-amino-α-methylbutyrate | Aabu | N-methyl-α-amino-α- | Nmaabu |
| | | methylbutyrate | |
| α-aminoisobutyric acid | Aib | N-methyl-α-aminoisobutyrate | Nmaib |
| D-α-methylarginine | Dmarg | L-α-methylarginine | Marg |
| D-α-methylasparagine | Dmasn | L-α-methylasparagine | Masn |
| D-α-methylaspartate | Dmasp | L-α-methylaspartate | Masp |
| D-α-methylcysteine | Dmcys | L-α-methylcysteine | Mcys |
| D-α-methylglutamine | Dmgln | L-α-methylglutamine | Mgln |
| D-α-methyl glutamic acid | Dmglu | L-α-methylglutamate | Mglu |
| D-α-methylhistidine | Dmhis | L-α-methylhistidine | Mhis |
| D-α-methylisoleucine | Dmile | L-α-methylisoleucine | Mile |
| D-α-methylleucine | Dmleu | L-α-methylleucine | Mleu |
| D-α-methyllysine | Dmlys | L-α-methyllysine | Mlys |
| D-α-methylmethionine | Dmmet | L-α-methylmethionine | Mmet |
| D-α-methylornithine | Dmorn | L-α-methylornithine | Morn |
| D-α-methylphenylalanine | Dmphe | L-α-methylphenylalanine | Mphe |
| D-α-methylproline | Dmpro | L-α-methylproline | Mpro |
| D-α-methylserine | Dmser | L-α-methylserine | Mser |
| D-α-methylthreonine | Dmthr | L-α-methylthreonine | Mthr |
| D-α-methyltryptophan | Dmtrp | L-α-methyltryptophan | Mtrp |
| D-α-methyltyrosine | Dmtyr | L-α-methyltyrosine | Mtyr |
| D-α-methylvaline | Dmval | L-α-methylvaline | Mval |
| N-cyclobutylglycine | Ncbut | L-α-methylnorvaline | Mnva |
| N-cycloheptylglycine | Nchep | L-α-methylethylglycine | Metg |
| N-cyclohexylglycine | Nchex | L-α-methyl-t-butylglycine | Mtbug |
| N-cyclodecylglycine | Ncdec | L-α-methyl-homophenylalanine | Mhphe |
| N-cyclododecylglycine | Ncdod | α-methyl-α-naphthylalanine | Manap |
| N-cyclooctylglycine | Ncoct | α-methylpenicillamine | Mpen |
| N-cyclopropylglycine | Ncpro | α-methyl-γ-aminobutyrate | Mgabu |
| N-cycloundecylglycine | Ncund | α-methyl-cyclohexylalanine | Mchexa |
| N-(2-aminoethyl)glycine | Naeg | α-methyl-cyclopentylalanine | Mcpen |
| N-(2,2- | Nbhm | N-(N-(2,2-diphenylethyl) | Nnbhm |
| diphenylethyl)glycine | | carbamylmethyl-glycine | |
| N-(3,3- | Nbhe | N-(N-(3,3-diphenylpropyl) | Nnbhe |
| diphenylpropyl)glycine | | carbamylmethyl-glycine | |
| 1-carboxy-1-(2,2-diphenyl- | Nmbc | 1,2,3,4-tetrahydroisoquinoline- | Tic |
| ethylamino) | | 3-carboxylic acid | |
| cyclopropane | | | |
| phosphoserine | pSer | phosphothreonine | pThr |
| phosphotyrosine | pTyr | O-methyl-tyrosine | |
| 2-aminoadipic acid | | hydroxylysine | |

The peptides of some embodiments of the invention are preferably utilized in a linear form, although it will be appreciated that in cases where cyclization does not severely interfere with peptide characteristics, cyclic forms of the peptide can also be utilized.

The peptides of some embodiments of the invention may be synthesized by any techniques that are known to those skilled in the art of peptide synthesis. For solid phase peptide synthesis, a summary of the many techniques may be found in J. M. Stewart and J. D. Young, Solid Phase Peptide Synthesis, W. H. Freeman Co. (San Francisco), 1963 and J. Meienhofer, Hormonal Proteins and Peptides, vol. 2, p. 46, Academic Press (New York), 1973. For classical solution synthesis see G. Schroder and K. Lupke, The Peptides, vol. 1, Academic Press (New York), 1965.

In general, these methods comprise the sequential addition of one or more amino acids or suitably protected amino acids to a growing peptide chain. Normally, either the amino or carboxyl group of the first amino acid is protected by a suitable protecting group. The protected or derivatized amino acid can then either be attached to an inert solid support or utilized in solution by adding the next amino acid in the sequence having the complimentary (amino or carboxyl) group suitably protected, under conditions suitable for forming the amide linkage. The protecting group is then removed from this newly added amino acid residue and the next amino acid (suitably protected) is then added, and so forth. After all the desired amino acids have been linked in the proper sequence, any remaining protecting groups (and any solid support) are removed sequentially or concurrently, to afford the final peptide compound. By simple modification of this general procedure, it is possible to add more than one amino acid at a time to a growing chain, for example, by coupling (under conditions which do not racemize chiral centers) a protected tripeptide with a properly protected dipeptide to form, after deprotection, a pentapeptide and so forth. Further description of peptide synthesis is disclosed in U.S. Pat. No. 6,472,505.

A preferred method of preparing the peptide compounds of some embodiments of the invention involves solid phase peptide synthesis.

Large scale peptide synthesis is described by Andersson (2000) Biopolymers, 55(3), 227-250.

Herein, a “homolog” of a given peptide refers to a peptide that exhibits at least 80% homology, preferably at least 90% homology, and more preferably at least 95% homology, and more preferably at least 98% homology to the given peptide (optionally exhibiting at least 80%, at least 90% identity, at least 95%, or at least 98% sequence identity to the given peptide). In some embodiments, a homolog of a given peptide further shares a therapeutic activity with the given peptide. The percentage of homology refers to the percentage of amino acid residues in a first peptide sequence which matches a corresponding residue of a second peptide sequence to which the first peptide is being compared. Generally, the peptides are aligned to give maximum homology. A variety of strategies are known in the art for performing comparisons of amino acid or nucleotide sequences in order to assess degrees of identity, including, for example, manual alignment, computer assisted sequence alignment and combinations thereof. A number of algorithms (which are generally computer implemented) for performing sequence alignment are widely available, or can be produced by one of skill in the art. Representative algorithms include, e.g., the local homology algorithm of Smith and Waterman (Adv. Appl. Math., 1981, 2: 482); the homology alignment algorithm of Needleman and Wunsch (J. Mol. Biol., 1970, 48: 443); the search for similarity method of Pearson and Lipman (Proc. Natl. Acad. Sci. (USA), 1988, 85: 2444); and/or by computerized implementations of these algorithms (e.g., GAP, BESTFIT, FASTA, and TFASTA in the Wisconsin Genetics Software Package Release 7.0, Genetics Computer Group, 575 Science Dr., Madison, Wis.). Readily available computer programs incorporating such algorithms include, for example, BLASTN, BLASTP, Gapped BLAST, PILEUP, CLUSTALW etc. When utilizing BLAST and Gapped BLAST programs, default parameters of the respective programs may be used. Alternatively, the practitioner may use non-default parameters depending on his or her experimental and/or other requirements (see for example, the Web site having URL www(dot)ncbi(dot)nlm(dot)nih(dot)gov).

As used herein throughout, the term “alkyl” refers to any saturated aliphatic hydrocarbon including straight chain and branched chain groups. Preferably, the alkyl group has 1 to 20 carbon atoms. Whenever a numerical range; e.g., “1 to 20”, is stated herein, it implies that the group, in this case the hydrocarbon, may contain 1 carbon atom, 2 carbon atoms, 3 carbon atoms, etc., up to and including 20 carbon atoms. More preferably, the alkyl is a medium size alkyl having 1 to 10 carbon atoms. Most preferably, unless otherwise indicated, the alkyl is a lower alkyl having 1 to 4 carbon atoms. The alkyl group may be substituted or non-substituted. When substituted, the substituent group can be, for example, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, 0-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, as these terms are defined herein.

Herein, the term “alkenyl” describes an unsaturated aliphatic hydrocarbon comprise at least one carbon-carbon double bond, including straight chain and branched chain groups. Preferably, the alkenyl group has 2 to 20 carbon atoms. More preferably, the alkenyl is a medium size alkenyl having 2 to 10 carbon atoms. Most preferably, unless otherwise indicated, the alkenyl is a lower alkenyl having 2 to 4 carbon atoms. The alkenyl group may be substituted or non-substituted. Substituted alkenyl may have one or more substituents, whereby each substituent group can independently be, for example, alkynyl, cycloalkyl, alkynyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, 0-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino.

Herein, the term “alkynyl” describes an unsaturated aliphatic hydrocarbon comprise at least one carbon-carbon triple bond, including straight chain and branched chain groups. Preferably, the alkynyl group has 2 to 20 carbon atoms. More preferably, the alkynyl is a medium size alkynyl having 2 to 10 carbon atoms. Most preferably, unless otherwise indicated, the alkynyl is a lower alkynyl having 2 to 4 carbon atoms. The alkynyl group may be substituted or non-substituted. Substituted alkynyl may have one or more substituents, whereby each substituent group can independently be, for example, cycloalkyl, alkenyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, 0-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino.

A “cycloalkyl” group refers to a saturated on unsaturated all-carbon monocyclic or fused ring (i.e., rings which share an adjacent pair of carbon atoms) group wherein one of more of the rings does not have a completely conjugated pi-electron system. Examples, without limitation, of cycloalkyl groups are cyclopropane, cyclobutane, cyclopentane, cyclopentene, cyclohexane, cyclohexadiene, cycloheptane, cycloheptatriene, and adamantane. A cycloalkyl group may be substituted or non-substituted. When substituted, the substituent group can be, for example, alkyl, alkenyl, alkynyl, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, 0-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, as these terms are defined herein. When a cycloalkyl group is unsaturated, it may comprise at least one carbon-carbon double bond and/or at least one carbon-carbon triple bond.

An “aryl” group refers to an all-carbon monocyclic or fused-ring polycyclic (i.e., rings which share adjacent pairs of carbon atoms) having a completely conjugated pi-electron system. Examples, without limitation, of aryl groups are phenyl, naphthalenyl and anthracenyl. The aryl group may be substituted or non-substituted. When substituted, the substituent group can be, for example, alkyl, alkenyl, alkynyl, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, as these terms are defined herein.

A “heteroaryl” group refers to a monocyclic or fused ring (i.e., rings which share an adjacent pair of atoms) having in the ring(s) one or more atoms, such as, for example, nitrogen, oxygen and sulfur and, in addition, having a completely conjugated pi-electron system. Examples, without limitation, of heteroaryl groups include pyrrole, furan, thiophene, imidazole, oxazole, thiazole, pyrazole, pyridine, pyrimidine, quinoline, isoquinoline and purine. The heteroaryl group may be substituted or non-substituted. When substituted, the substituent group can be, for example, alkyl, alkenyl, alkynyl, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, 0-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, as these terms are defined herein.

A “heteroalicyclic” group refers to a monocyclic or fused ring group having in the ring(s) one or more atoms such as nitrogen, oxygen and sulfur. The rings may also have one or more double bonds. However, the rings do not have a completely conjugated pi-electron system. The heteroalicyclic may be substituted or non-substituted. When substituted, the substituted group can be, for example, alkyl, alkenyl, alkynyl, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, 0-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, as these terms are defined herein. Representative examples are piperidine, piperazine, tetrahydrofuran, tetrahydropyran, morpholine and the like.

Herein, the terms “amine” and “amino” each refer to either a —NR′R″ group or a —N+R′R″R′″ group, wherein R′, R″ and R′″ are each hydrogen or a substituted or non-substituted alkyl, alkenyl, alkynyl, cycloalkyl, heteroalicyclic (linked to amine nitrogen via a ring carbon thereof), aryl, or heteroaryl (linked to amine nitrogen via a ring carbon thereof), as defined herein. Optionally, R′, R″ and R′″ are hydrogen or alkyl comprising 1 to 4 carbon atoms. Optionally, R′ and R″ (and R′″, if present) are hydrogen. When substituted, the carbon atom of an R′, R″ or R′″ hydrocarbon moiety which is bound to the nitrogen atom of the amine is not substituted by oxo (unless explicitly indicated otherwise), such that R′, R″ and R′″ are not (for example) carbonyl, C-carboxy or amide, as these groups are defined herein.

An “azide” group refers to a —N═N⁺═N⁻group.

An “alkoxy” group refers to any of an —O-alkyl, —O-alkenyl, —O-alkynyl, —O-cycloalkyl, and —O-heteroalicyclic group, as defined herein.

An “aryloxy” group refers to both an —O-aryl and an —O-heteroaryl group, as defined herein.

A “hydroxy” group refers to a —OH group. A “thiohydroxy” or “thiol” group refers to a —SH group.

A “thioalkoxy” group refers to any of an —S-alkyl, —S-alkenyl, —S-alkynyl, —S-cycloalkyl, and —S-heteroalicyclic group, as defined herein.

A “thioaryloxy” group refers to both an —S-aryl and an —S-heteroaryl group, as defined herein.

A “carbonyl” or “acyl” group refers to a —C(═O)—R′ group, where R′ is defined as hereinabove.

A “thiocarbonyl” group refers to a —C(═S)—R′ group, where R′ is as defined herein.

A “C-carboxy” group refers to a —C(═O)—O—R′ group, where R′ is as defined herein.

An “O-carboxy” group refers to an R′C(═O)—O— group, where R′ is as defined herein.

A “carboxylic acid” group refers to a —C(═O)OH group.

An “oxo” group refers to a ═O group.

An “imine” group refers to a ═N—R′ group, where R′ is as defined herein.

An “oxime” group refers to a ═N—OH group.

A “hydrazone” group refers to a ═N—NR′R″ group, where each of R′ and R″ is as defined herein.

A “halo” group refers to fluorine, chlorine, bromine or iodine.

A “sulfinyl” group refers to an —S(═O)—R′ group, where R′ is as defined herein.

A “sulfonyl” group refers to an —S(═O)₂—R′ group, where R′ is as defined herein.

A “sulfonate” group refers to an —S(═O)₂—O—R′ group, where R′ is as defined herein.

A “sulfate” group refers to an —O—S(═O)₂—O—R′ group, where R′ is as defined as herein.

A “sulfonamide” or “sulfonamido” group encompasses both S-sulfonamido and N-sulfonamido groups, as defined herein.

An “S-sulfonamido” group refers to a —S(═O)₂—NR′R″ group, with each of R′ and R″ as defined herein.

An “N-sulfonamido” group refers to an R'S(═O)₂—NR″— group, where each of R′ and R″ is as defined herein.

An “O-carbamyl” group refers to an —OC(═O)—NR′R″ group, where each of R′ and R″ is as defined herein.

An “N-carbamyl” group refers to an R′OC(═O)—NR″— group, where each of R′ and R″ is as defined herein.

An “O-thiocarbamyl” group refers to an —OC(═S)—NR′R″ group, where each of R′ and R″ is as defined herein.

An “N-thiocarbamyl” group refers to an R′OC(═S)NR″— group, where each of R′ and R″ is as defined herein.

An “S-thiocarbamyl” group refers to an —SC(═O)—NR′R″ group, where each of R′ and R″ is as defined herein.

An “amide” or “amido” group encompasses C-amido and N-amido groups, as defined herein.

A “C-amido” group refers to a —C(═O)—NR′R″ group, where each of R′ and R″ is as defined herein.

An “N-amido” group refers to an R′C(═O)—NR″— group, where each of R′ and R″ is as defined herein.

A “urea group” refers to an —N(R′)—C(═O)—NR″R′″ group, where each of R′, R″ and R″ is as defined herein.

A “thiourea group” refers to a —N(R′)—C(═S)—NR″R′″ group, where each of R′, R″ and R″ is as defined herein.

A “nitro” group refers to an —NO2 group.

A “cyano” group refers to a —C≡N group.

The term “phosphonyl” or “phosphonate” describes a —P(═O)(OR′)(OR″) group, with R′ and R″ as defined hereinabove.

The term “phosphate” describes an —O—P(═O)(OR′)(OR″) group, with each of R′ and R″ as defined hereinabove.

The term “phosphinyl” describes a —PR′R″ group, with each of R′ and R″ as defined hereinabove.

The term “hydrazine” describes a —NR′—NR″R′″ group, with R′, R″, and R′″ as defined herein.

As used herein, the term “hydrazide” describes a —C(═O)—NR′—NR″R′″ group, where R′, R″ and R′″ are as defined herein.

As used herein, the term “thiohydrazide” describes a —C(═S)—NR′—NR″R′″ group, where R′, R″ and R′″ are as defined herein.

A “guanidinyl” group refers to an —RaNC(=NRd)-NRbRc group, where each of Ra, Rb, Re and Rd can be as defined herein for R′ and R″.

A “guanyl” or “guanine” group refers to an RaRbNC(=NRd)-group, where Ra, Rb and Rd are as defined herein.

For any of the embodiments described herein, a peptide as described herein (also referred to herein as a “compound”) may be in a form of a salt, for example, a pharmaceutically acceptable salt, and/or in a form of a prodrug.

As used herein, the phrase “pharmaceutically acceptable salt” refers to a charged species of the parent compound and its counter-ion, which is typically used to modify the solubility characteristics of the parent compound and/or to reduce any significant irritation to an organism by the parent compound, while not abrogating the biological activity and properties of the administered compound.

In the context of some of the present embodiments, a pharmaceutically acceptable salt of the compounds described herein may optionally be an acid addition salt and/or a base addition salt, depending on the nature of amino acid residues composing the peptide.

An acid addition salt comprises at least one basic (e.g., amine and/or guanidinyl) group of the compound which is in a positively charged form (e.g., wherein the basic group is protonated), in combination with at least one counter-ion, derived from the selected acid, that forms a pharmaceutically acceptable salt. The acid addition salts of the compounds described herein may therefore be complexes formed between one or more basic groups of the compound and one or more equivalents of an acid.

A base addition salt comprises at least one acidic (e.g., carboxylic acid) group of the compound which is in a negatively charged form (e.g., wherein the acidic group is deprotonated), in combination with at least one counter-ion, derived from the selected base, that forms a pharmaceutically acceptable salt. The base addition salts of the compounds described herein may therefore be complexes formed between one or more acidic groups of the compound and one or more equivalents of a base.

Depending on the stoichiometric proportions between the charged group(s) in the compound and the counter-ion in the salt, the acid additions salts and/or base addition salts can be either mono-addition salts or poly-addition salts.

The phrase “mono-addition salt”, as used herein, refers to a salt in which the stoichiometric ratio between the counter-ion and charged form of the compound is 1:1, such that the addition salt includes one molar equivalent of the counter-ion per one molar equivalent of the compound.

The phrase “poly-addition salt”, as used herein, refers to a salt in which the stoichiometric ratio between the counter-ion and the charged form of the compound is greater than 1:1 and is, for example, 2:1, 3:1, 4:1 and so on, such that the addition salt includes two or more molar equivalents of the counter-ion per one molar equivalent of the compound.

An example, without limitation, of a pharmaceutically acceptable salt would be an ammonium cation or guanidinium cation and an acid addition salt thereof, and/or a carboxylate anion and a base addition salt thereof.

The base addition salts may include a cation counter-ion such as sodium, potassium, ammonium, calcium, magnesium and the like, that forms a pharmaceutically acceptable salt.

The acid addition salts may include a variety of organic and inorganic acids, such as, but not limited to, hydrochloric acid which affords a hydrochloric acid addition salt, hydrobromic acid which affords a hydrobromic acid addition salt, acetic acid which affords an acetic acid addition salt, ascorbic acid which affords an ascorbic acid addition salt, benzenesulfonic acid which affords a besylate addition salt, camphorsulfonic acid which affords a camphorsulfonic acid addition salt, citric acid which affords a citric acid addition salt, maleic acid which affords a maleic acid addition salt, malic acid which affords a malic acid addition salt, methanesulfonic acid which affords a methanesulfonic acid (mesylate) addition salt, naphthalenesulfonic acid which affords a naphthalenesulfonic acid addition salt, oxalic acid which affords an oxalic acid addition salt, phosphoric acid which affords a phosphoric acid addition salt, toluenesulfonic acid which affords a p-toluenesulfonic acid addition salt, succinic acid which affords a succinic acid addition salt, sulfuric acid which affords a sulfuric acid addition salt, tartaric acid which affords a tartaric acid addition salt and trifluoroacetic acid which affords a trifluoroacetic acid addition salt. Each of these acid addition salts can be either a mono-addition salt or a poly-addition salt, as these terms are defined herein.

As used herein, the term “prodrug” refers to a compound which is converted in the body to an active compound (e.g., the compound of the formula described hereinabove). A prodrug is typically designed to facilitate administration, e.g., by enhancing absorption. A prodrug may comprise, for example, the active compound modified with ester groups, for example, wherein any one or more of the hydroxyl groups of a compound is modified by an acyl group, optionally (C₁₋₄)-acyl (e.g., acetyl) group to form an ester group, and/or any one or more of the carboxylic acid groups of the compound is modified by an alkoxy or aryloxy group, optionally (C₁₋₄)-alkoxy (e.g., methyl, ethyl) group to form an ester group.

Further, each of the compounds described herein, including the salts thereof, can be in a form of a solvate or a hydrate thereof.

The term “solvate” refers to a complex of variable stoichiometry (e.g., di-, tri-, tetra-, penta-hexa-, and so on), which is formed by a solute (the heterocyclic compounds described herein) and a solvent, whereby the solvent does not interfere with the biological activity of the solute.

The term “hydrate” refers to a solvate, as defined hereinabove, where the solvent is water.

The compounds described herein can be used as polymorphs and the present embodiments further encompass any isomorph of the compounds and any combination thereof.

The compounds and structures described herein encompass any stereoisomer, including enantiomers and diastereomers, of the compounds described herein, unless a particular stereoisomer is specifically indicated.

As used herein, the term “enantiomer” refers to a stereoisomer of a compound that is superposable with respect to its counterpart only by a complete inversion/reflection (mirror image) of each other. Enantiomers are said to have “handedness” since they refer to each other like the right and left hand. Enantiomers have identical chemical and physical properties except when present in an environment which by itself has handedness, such as all living systems. In the context of the present embodiments, a compound may exhibit one or more chiral centers, each of which exhibiting an (R) or an (S) configuration and any combination, and compounds according to some embodiments of the present invention, can have any their chiral centers exhibit an (R) or an (S) configuration.

The term “diastereomers”, as used herein, refers to stereoisomers that are not enantiomers to one another. Diastereomerism occurs when two or more stereoisomers of a compound have different configurations at one or more, but not all of the equivalent (related) stereocenters and are not mirror images of each other. When two diastereoisomers differ from each other at only one stereocenter they are epimers. Each stereo-center (chiral center) gives rise to two different configurations and thus to two different stereoisomers. In the context of the present invention, embodiments of the present invention encompass compounds with multiple chiral centers that occur in any combination of stereo-configuration, namely any diastereomer.

As used herein the term “about” refers to ±10% or ±5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

Herein throughout, the phrase “room temperature”, abbreviated as RT or r.t., describes a temperature in a range of from 20 to 25, or from 23 to 25, or of about 25, ° C.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### MATERIALS AND EXPERIMENTAL METHODS

Powder X-ray diffraction (PXRD): For diffraction analysis, the XRD pattern of the assembled peptide glassy material was collected using a Bruker's D8 Discover Diffractometer; the X-ray source was a typical Cu anode radiation, and the detector was a LYNXEYE XE linear detector, set in order to collect only the Cu Kal, 2 wavelength. The data were collected using a parallel-focalized beam (Göbels Mirror) using a 20 scan. The data were collected using a Bragg-Brentano geometry with a 0-0 setup. All diffraction patterns were collected between 5 and 40° 2θ with step 0.020 2θ for 1 second per step.

Differential scanning calorimetry (DSC): The change in heat flow was measured using a thermal analyzer (DSC 25 TA).

The glass transition is shown as a step in the heat flow trace. For the analysis of the glass transition temperature, two construction tangents to the heat flow baseline were defined. A third tangent was constructed through the inflection point of the step. The glass transition was determined by the half-height analysis method. According to this method, the glass transition temperature is defined as the temperature corresponding to the Y-axis value of the halfway between two intersection points of the three analysis constructs.

For the measurement, the sample was placed in an alumina crucible, while heat flow was calculated compared to an empty alumina crucible as a reference. In all measurements, heating and cooling rates were 10° C./minute. For the experiment involved heating cycles of 70, 100, 110, and 120° C., an isothermal stage was held for 10 minutes after each cycle.

NOESY: The NOESY experiment was carried on a Bruker Avance Neo spectrometer operating at 9.4 T. The carrier frequency was set to be 4.6 ppm. 32 scans were collected for each point in the indirect dimension with a recycle delay of 0.5 seconds. The acquisition mode in the indirect dimension was STATES. The spectrum was processed in NMRPipe and Sparky version 3.134. Apodization: Lorentzian to Gaussian in the direct dimension and cosine bell squared in the indirect dimension. Linear prediction and zero filling of 512 was used for the indirect dimension only.

Adhesive measurements: Shear test measurements were performed using an Instron 4502. The sample was prepared by applying 10 microliters of a 100 mg/ml solution between two microscope glass slides, covering an area of 25 mm² and allowing it to evaporate. Each of the adhered microscope glass slides was fastened firmly between two screw side action grips. The samples were pulled apart using a 10 kN load cell at a cross speed of 1 mm/minute. The load vs. displacement of the load were recorded and plotted.

Transmittance: For transmittance measurements in the ultraviolet and visible range, 10 l (microliters) of a 100 mg/ml YYY aqueous solution were allowed to evaporate spontaneously between two microscope glass slides. The transparency spectra of the peptide layer sandwich between the glass slides was recorded between 300-800 nm wavelengths, using a UV-Vis spectrophotometer (JASCO V-770) and compared to two overlapping glass slides having evaporated water therebetween as a control.

For transmittance measurements in infra-red range, 10 μl of a 100 mg/ml YYY aqueous solution were allowed to evaporate spontaneously between two Zinc Sulfide multispectral plates (ZnS). The transparency spectra of the peptide layer sandwich between the plates was recorded between 2.5-15 m wavelengths, on a FT-IR spectrometer (PerkinElmer, Spectrum 100), and compared to two overlapping plates having evaporated water therebetween as a control.

Refractive Index: The matching refractive index was measured using Sentech SE 800 Spectroscopic Ellipsometer, between the wavelength range of 400 nm to 820 nm. A uniform peptide glass layer was deposited on a silicon wafer, and compared to a similar substrate as a reference. The silicon wafer substrate had 7.2 nm of Si-oxide, and for the measurement, an angle offset at 0.9 degrees (for an angle of incidence of 50 degrees) was defined. The peptide glass thin layer is modeled as a Cauchy layer. The matching refractive index is calculated as:

$$n ( Lambda ) = {n}_{0} + \frac{100 * {n}_{1}}{{( Lambda )}^{2}} + \frac{1 {0}^{7} * {n}_{2}}{{( Lambda )}^{4}}$$

The wavelength Lambda is in nm.

The measurement was performed 6 times, and the data present the average and deviation error.

Peptide glass optical lenses measurements: To form the lenses in a reproducible matter, a glass slide patterned with polytetrafluoroethylene (PTFE) was used. A pre-determined volume of a YYY peptide solution in water (100 mg/ml) was added and water was allowed to evaporate spontaneously at room temperature. The three setups of the experiment were with a 30 μl peptide lens, a 15 μl peptide lens, and a glass slide (no peptide lens) as a control, using a YYY peptide solution (100 mg/ml).

The focal length is given by the equation

$$\frac{1}{f} = \frac{1}{u} + \frac{1}{v} ,$$

wherein f is the focal length, u is the lens' distance from the objective, and v is the camera's distance from the lens (remained constant at 15 cm at the tested setup), as schematically illustrated in FIG. 5C.

Cryogenic Scanning Electron Microscopy (cryo-SEM) imaging: 1.5 L of YYY solutions (50 mg/mL and 500 mg/mL) were sandwiched between two aluminum discs (25 m groves) and cryo-immobilized in a high-pressure freezing (HPF) device (EM ICE, Leica). Then, the frozen samples were mounted on a sample holder under liquid nitrogen in a specialized loading station (EM VCM, Leica) and transferred via shuttle (EM VCT500, Leica) under cryogenic conditions to a sample preparation freeze-fracture device (EM ACE900, Leica). The samples were fractured at a speed of 120 mm/second, etched for 40 minutes at −110° C., and coated with 3 nm of PtC.

The freeze-fractured samples were imaged in a HRSEM Gemini 300 SEM (Zeiss) by secondary electron in-lens detector while maintaining an operating temperature of −120° C.

Scanning electron microscopy (SEM): For electron microscopy analysis, the peptide solution was left to dry at ambient conditions on a silicon substrate. After coating with a thin film of Au, the samples were imaged by a GeminiSEM 300 field emission scanning electron microscope (Zeiss Inc., Germany) at an electron beam with a landing energy of 3 KV, and by JCM 6000plus Neoscope Benchtop (Jeol Inc., Japan) operating at 15 kV.

Thermogravimetric analysis (TGA): The changes in mass caused by water evaporation were analyzed using a thermal gravity analyzer (Labsys Evo, Setaram). The experiment involved heating the same sample in four isothermal stages at temperatures of 70, 100, 110, and 120° C., respectively, using an alumina crucible. Each isothermal stage was held for 10 minutes. Both the heating and cooling rates were 10° C./minute. Prior to each isothermal stage, the sample was cooled to room temperature before being reheated for the next isothermal cycle. All measurements were carried out under a 30 ml/minute Argon (99.999%) flow. Two separate TGA runs were performed, one with the sample and another with empty crucibles serving as blank, both under the same experimental conditions. The blank measurements were then subtracted from the sample measurements to obtain accurate results.

Mass spectrometry (MS): Post thermal heating cycles, the glass sample was dissolve in DDW and the mass spectra were measured using an Acquity Ultra performance liquid chromatography (Waters Inc., USA) at 230 nm and Xevo TQD (Waters Inc., USA) at ESI (electron spray ionization) method at both positive and negative ESI.

Nano indentation: Reduced Young's modulus and hardness were measured using a Nanoindenter equipped with a Berkovich tip (Hysitron TS 77 Select, Bruker) under a maximum load of 1000 μN and dwell time of 5 seconds.

Materials:

All tested peptides were obtained from Genscript.

### Example 1

### Water-Solubility of Short Peptides

The self-assembly process of di- and tri-peptides consisting of Y and/or F residues in water was examined.

As described in the Background section hereinabove, the solubility of a building block in a given solvent is an important parameter in the self-assembly process.

To determine whether the order of amino acids within a peptide sequence has any effect on its solubility, solubility in water was examined for the amino acids F and Y, as well as for all possible dipeptides and tripeptides containing them (general structures are presented in FIG. 1).

Each amino acid or peptide was weighed. Water was gradually added at room temperature and the solution was vortexed. After each addition of water, the solution was sampled and evaluated under light microscopy; this process was repeated until no visible particles were detected and the concentration was calculated and determined as the solubility limit of the peptide in water.

The results are summarized in Table 1.

TABLE 1

| | Solubility |
|---|---|
| Peptide | [milligram/milliliter] |
| F | 29.6 (literature) |
| Y | 0.45 (literature) |
| FF | 0.76 (literature) |
| FY | >1000 |
| YF | >1000 |
| YY | >1000 |
| FFF | <1 |
| FFY | >250 |
| FYF | <5 |
| YFF | >250 |
| FYY | >1000 |
| YFY | >1000 |
| YYF | >1000 |
| YYY | >1000 |

The solubility of F and Y single amino acids was previously compared [Ji et al. (2019) supra]. The water solubility of Y is almost two orders of magnitude lower than that of F, although Y is considered a more hydrophilic molecule. The solubility of diphenylalanine (FF) is also higher than that of a single Y [see, for example, Mason et al. (2014) supra; and Arnon et al. (2016) supra].

Surprisingly, by adding the hydrophobic F to the sequence of Y, whether once for dipeptides (YF, FY) or twice for tripeptides (YFF, YFY, FFY), the solubility drastically increases by several orders of magnitude.

Tri-peptides containing two F and a single Y revealed different solubility from each other, depending on the sequence order. While YFF and FFY tri-peptides are soluble at a concentration of above 250 mg/mL, the solubility of FYF is notably lower, at below 5 mg/mL, which indicates that the order of amino acids has an effect on the solubility of the peptides, which is in contrast to the consensus.

The difference in solubility between the soluble and insoluble samples is notably significant and unanticipated, more than 50-fold higher.

Without being bound to any particular theory, it is assumed that solubility is not affected by the amino acid building blocks that form the peptide, but rather by the actual complex formed in solution through non-covalent interactions.

### Example 2

### Glass-Like Peptide-Based Materials

While studying the self-assembly of di- and tri-peptides of Y and/or F in aqueous solutions, the present inventors have uncovered, by serendipity, that following several hours of incubating short peptides at room temperature while pursuing self-assembly, small particles floating in the supposedly fully dissolved solutions of YFF and FFY were observed.

Since solutions of molecules that can readily dissolve at room temperature are considered to be below the critical concentration for the occurrence of self-assembly [see, for example, Mason et al. (2014) supra; Arnon et al. (2016) supra; and Mason et al. J. Am. Chem. Soc. 139, 16134-16142 (2017)], the observed phenomenon was unexpected and surprising. The particles were small rod-shaped crystallized assemblies, as shown in the optical microscopy data presented in FIGS. 2A-2C.

In order to compare the untreated tripeptide powder with the formed crystallized structures of tripeptides, the crystallized solutions of YFF and FFY were freeze-dried. The dried lyophilized powders were analyzed by powder X-ray diffraction (PXRD) in comparison with the untreated powders, and the obtained data is presented in FIGS. 2D-F.

Data from PXRD showed that while the untreated powders of the so-called “soluble peptides”, YFF and FFY, are initially amorphous and crystals are formed once the peptides dissolve, FYF is crystalline throughout. The lyophilized crystals of all three peptides are significantly less soluble, similar to the untreated FYF powder (that features water solubility of less than 5 mg/mL at room temperature).

While further studying the different solubility of the tripeptides, a drop of YYY solution was incubated at room temperature for several days followed by water evaporation. Consequently, the solution formed a transparent glass-like material in the shape of the drop. Once the water evaporated from the YYY solution, its volume slightly decreased and the remaining solid formed this rigid structure.

In order to study this intriguing finding, a sample of 10 L of YYY 100 milligram/mL solution was deposited between two microscope glass slides, forming a thin film of the solution due to capillarity action between the overlapping slides. The sample was then allowed to dry for several days at room temperature, providing a clear, see-through (e.g., transparent) material as depicted in FIG. 3A.

Glass-like shards of the YYY materials, as shown in FIG. 3B, were also obtained by evaporating a solution (100 mg/mL) of YYY at 50° C. It is assumed that accelerated evaporation at elevated temperatures provided a more amorphous shard structure.

Visible light transmittance (VLT) measurements were then performed, comparing the VLT of the YYY thin film between the two overlapping slides with the VLT of two overlapping microscope slides that were subjected to similar conditions with evaporated 10 L water. As shown in FIG. 3C, while the two overlapping slides have 80% VLT, the overlapping slides with YYY film in between has an increased 90% VLT, indicating it possesses similar VLT to that of clear glass [Serrano and Moreno, Journal of Photochemistry and Photobiology B: Biology 208, 111894 (2020)].

In order to assess the difference between the crystallized structures of the glass-like YYY film and the untreated white YYY powder, a powder X-ray diffraction (PXRD) analysis was performed. As shown in FIG. 3D, PXRD revealed that both structures, and especially the powder, are amorphous, evidenced by the lack of discrete Bragg scattering peaks. The transparent film shows low levels of crystallinity, similar to silica glass. This means that tripeptide YYY molecules within the glass-like material are forming a continual array of molecular interactions with no definitive organization, giving the material its rigidity.

Differential scanning calorimetry (DSC) thermogram measurements of an exemplary glass-like peptide material were performed, and are presented in FIG. 3E. As can be seen, a glass transition was observed at 37° C. This result indicates that glassy material formed of the YYY solution is at a solid glass phase at room temperature.

Considering the PXRD and DSC data, the dried exemplary YYY glassy material shares two fundamental glass characteristics: it shows an amorphous organization and exhibits a time-dependent glass transformation behavior [J. E. Shelby, Introduction to Glass Science and Technology (2005)].

The transmittance spectra of the exemplary glass-like dried YYY material was compared to silicate glass (specifically, to zinc sulfide (ZnS) multispectral plates with evaporated water in between), and the obtained data is presented in FIG. 3F. As can be seen, a similar behavior in the infrared (IR) and visible light (VLT) regions was observed, showing that the peptide glass implementation did not interfere with the spectral range of the transmission by absorbance, indicating exceptional transparency, up to 12 m in the mid-infrared. Furthermore, the YYY glassy material resulted in a higher transmittance compared to the two ZnS plates by themselves, especially from wavelength higher than 1 m. However, due to the presence of essential water molecules in the glass assembly, the spectral fingerprint of water could be observed by an O—H stretch absorbance of 4% between 2800-3300 nm [Y. Maréchal, J. Chem. Phys. 95, 5565-5573 (1991)].

Comparative ellipsometry measurements were also performed and the obtained data is shown in FIG. 3G. The dried YYY glassy material is also similar to silicate glass in terms of the measured refractive index (about 1.52). Overall, the data indicate that water-soluble tripeptides can assemble to generate glass-like clear, transparent, non-crystalline (amorphous) and rigid materials.

In order to study the mechanism of the unexpected amorphous organization, a ¹H—¹H Nuclear Overhauser Effect Spectroscopy (NOESY) experiment was conducted on a sample of a glass-like solid YYY assembled by evaporating the aqueous solution and dissolving in DMSO-d₈. The experiment (data not shown) revealed strong NOE correlations between water protons and hydroxyl and amino protons of the peptide. These correlations imply non-exchangeable water molecules that form strong hydrogen bonds with the peptide molecules, as shown in FIG. 3H.

The formation of intermolecular hydrogen bonds were also confirmed by solution NMR (data not shown). The non-exchangeability of the water molecules and their localization were also supported by a ²H magic-angle spinning (MAS) solid state NMR (ssNMR) ‘solid-echo’ experiment [Davis et al. Chem. Phys. Lett. 42, 390-394 (1976)](data not shown), which indicated that water play a role in the stabilization of the glass-like YYY peptide structure (data not shown).

Without being bound to any particular theory, it is likely that the structural water function as a bridge between peptide molecules, thus stabilizing the overall structure. The amorphous properties of the glass-like YYY peptide structure imply that the hydrogen bonds patterns are random, resulting in a non-crystalline structure consistent with its glassy nature.

Herein throughout, the phrases YYY glassy material, glass-like YYY material, YYY peptide structure, YYY peptide material, and like phrases are all meant to describe the material formed from an aqueous solution containing YYY, upon evaporation of the water.

### Example 3

### Adhesion Performance Tests

In addition to its transparency, the tested self-assembled exemplary tri-peptide according to some of the present embodiments, YYY, was strongly adhering to the glass slide following water evaporation. The adhesive properties of the YYY exemplary peptide material were evaluated by applying an aqueous solution of YYY in the interface between two glass slides and allowing it to dehydrate. The adhesion was consequentially assessed by applying different forces onto the glass slides.

A sample of 10 μl of YYY 100 mg/mL [1 milligram (mg) YYY] solution was deposited between the narrow edge of one glass slide and perpendicular to the other slide, as shown in FIG. 4A. The dried sample held the two slides together and was able to support the weight of the slides with relative ease also in such a configuration. The overlapping area of the slides in this configuration is 1 mm×25 mm.

A dried sample between two glass slides with an overlapping area of 25 squared mm with 10 μl of 100 mg/mL YYY solution [1 milligram (mg) YYY], as described in Example 2 and FIG. 3A, has firmly held the two slides together. In order to quantify this trait, a small hole was drilled in one slide, which is also visible in FIG. 3A. A string loop was then tied to the hole in the slide. Then, a couple of 2.5 kilogram weights (total of 5 kilogram) were tied to the string, while holding the undrilled slide, which was entirely supported by the adhesive YYY sample holding the construct together (FIG. 4B).

In order to assess the load that YYY samples can hold quantitatively, single lap shear test measurements was performed using a tensile measurement device [see, for example, Abramowitch and Easley, Biomechanics of the Female Pelvic Floor 89-107 Elsevier Inc. (2016); and Kelly, Compos. Struct. 69, 35-43 (2005)]. As shown in FIG. 4C, the two adhered slides were firmly fastened between two screw side action grips. The samples were pulled apart using a 10 kN load cell at a cross speed of 1 mm/minute. The load vs. displacement of the cell were recorded and plotted, and the data are summarized in Table 2. Representative data from Sample 1 are plotted in FIG. 4D.

TABLE 2

| Sample | Failure load (N) | Displacement (mm) |
|---|---|---|
| 1 | 280.2 | 0.18 |
| 2 | 246.2 | 0.26 |
| 3 | 206.2 | 0.17 |
| 4 | 192.1 | 0.20 |
| 5 | 276.7 | 0.18 |
| Average | 240 ± 35.9 | 0.20 ± 0.03 |

The results reveal that the average sample failure is equivalent to almost 400 kPa of stress, and that a small area of 25 mm by 25 mm or 625 mm² can hold an average of 24 kilograms (calculated as follows: 240 N (24 Kg)/0.000625 m² (0.025 m×0.025 m)=384000 Pa)).

Failure of the adhesive was observed in all samples, indicating the sample is quite rigid, and once it breaks, it loses its adhesion. Sample remnants were visible on both separated glass slides, suggesting that this is a cohesion failure between the YYY peptide molecules, and not between the glass slide and the sample.

In additional experiments, the adhesive properties after heating the sample to 200° C., and after cooling it with liquid nitrogen were evaluated. No substantial change in the adhesive properties was observed (data not shown), indicating a thermal stability through a wide temperature range.

Taken together, these data suggest that the strong intermolecular hydrogen bond interactions allow the application of the YYY peptide solution as an adhesive for hydrophilic surfaces as illustrated in FIG. 4E.

Increasing the cohesion performance of the peptide material was achieved under conditions that can promote cross-linking of the tyrosine to thereby form di-tyrosine covalent bonds. In an exemplary procedure, a YYY peptide solution which further comprises hydrogen peroxide (e.g., 1-10%) was used to form the YYY adhesive material. Then, the adhesive material, placed between the surfaces, was either heated, for example, at 60° C. for 1 hour or, for example, left at ambient temperature for 24 hours, for inducing water evaporation. The dried material was exposed to a short UV irradiation, although cross-linking was observed also without UV irradiation. The cross linking was verified spectroscopically.

Without introduction of water molecules, the raw YYY peptide is a white solid powder without any adhesive properties. However, when the initially dry peptide powder is exposed to a humid environment, it absorbs water and converts into a highly viscous transparent sticky material, emphasizing the role of the water in establishing extremely strong intermolecular hydrogen bonds.

As suggested by the supramolecular structure of the peptide glassy material, water molecules enable the conversion of the low-molecular weight monomeric peptide into a supramolecular adhesive polymer [Dong et al., Sci. Adv. 3, 1-9 (2017); Zhang et al. J. Am. Chem. Soc. 141, 8058-8063 (2020)], presenting a facile direction of adhesive application, in mild environments, without a need for high thermal or pressure conditions.

The wetting angle of water and a YYY solution on a glass surface was examined, and a photograph of the results is presented in FIG. 4F. This indicates that the peptide lowers the surface tension of water, acting as a wetting agent. Wettability is one of the fundamental aspects of adhesion science as it allows the formation of intimate contact between the adhesive and the adherent. This leads to maximal interfacial adhesive bond strength by minimizing the intermolecular forces across interfaces. Furthermore, low molecular weight adhesives will benefit in terms of reaching the ultimate interfacial bonding capability.

### Example 4

### Peptide-Based Lenses

The performance of the exemplary YYY peptide solution was tested on a PDMS hydrophobic substrate, and it was found that application of 10 microliters of a 100 mg/ml solution of the peptide, followed by spontaneous water evaporation at room temperature results in a glass-like YYY peptide that features a curvature of a lens, as shown in FIG. 5A.

The capability of the glass-like YYY material to function as an optical convex lens was therefore tested. Custom Teflon (PTFE) coated glass slide with circular wells, as a template for uniform diameter peptide lens fabrication was used, as shown in FIG. 5B. The curvature of the resulting lens is dependent on the initial volume used in the well (see bottom of the image).

As the curvature of a lens determines its focal length, measuring the change between focal lengths of different lenses produced by varied volumes was targeted. For this purpose, a small object (the digit ‘1’ patterned with PTFE) was used to contain the peptide solution (100 mg/ml) while evaporating before being photographed by a camera using varied optical setups, as described herein and in FIG. 5C. The results are presented in FIG. 5D. As can be seen, the experimental setup demonstrates that with no focusing lens, the image is blurred (top row). With a lens formed of 30 μl solution, the curvature is relatively high, thus the distance from the object (u) where the image of the digit 1 is the sharpest is at about 17.5 cm, (focal length f of about 8 cm; middle row). With a lens formed of 15 μl solution, the distance from the object (u) is at about 32.5 cm (focal length of about 10 cm).

By imaging a focused object in different magnifications, the photographs (FIG. 5D) demonstrate the ability of the peptide glass to function as an optical lens.

### Example 5

### The Effect of Water Content on the Properties of Glass-Like Peptides

Dynamic modulation of the mechanical properties in response to water content is observed in complex biological materials, and can alter their mechanical properties depending on the environmental conditions [Ihli et al. Nat. Commun. 12, 25613-25614 (2021)].

The present inventors have observed that when exposed to a saturated humid environment, the glass-like YYY peptide material appears to be ductile, whereby in its dry state it is hard and brittle.

In order to further study this phenomenon, a photograph and a scanning electron microscopy (SEM or Cryo-SEM) image of the glass-like YYY peptide material were taken following dehydration and following hydration, and the obtained data is shown in FIGS. 6A-H.

As FIGS. 6A-B show, from a macroscopic point of view, that the hydrated glass shows highly ductile fracture generated through a tensile test (FIG. 6A). The hydrated state was imaged by freeze fracturing a cryo-immobilized sample (FIG. 613) and shows a nanometric scale ductile plastic deformation of the hydrated YYY peptide material.

Such drawn morphology arising from plastic deformation indicates clear inherent polymeric characteristics. Moreover, it demonstrates competent intermolecular cohesive forces formed by dense non-covalent crosslinking in the presence of water.

As shown in FIGS. 6C-D, from a macroscopic point of view, the dried glass-like YYY peptide material, obtained following dehydration under high vacuum, is hard and brittle, as observed by the peptide matter shards (FIG. 6C), which resemble those of silicate glass. As can be seen in the cryogenic SEM image shown in FIG. 6D, brittle cracks are observed in the dry state. The thermodynamic properties of the exemplary YYY peptide structure were examined by DSC. FIG. 6E presents DSC measurements of the glassy-like YYY peptide material in several heating cycles, and shows that the glass transition temperature (Tg) of the peptide glass is increasing due to cumulative effect of each previous heating cycle. Mass spectrometry (data not shown) suggested that no chemical decomposition occurred, indicating that the observed weight loss is solely due to water dehydration. These data indicate that the increasing values of Tg in each heating cycle stems from the decreasing in the water content in the peptide.

After a 7-hour 120° C. isothermal incubation, the glass transition temperature was no longer affected by the heating cycles and remained at a constant value of 119° C. even after heating up to 150° C., as can be seen in FIG. 6F. Assuming that the glass-like YYY peptide material had lost all plasticizing water molecules, it should approach its highest hardness properties.

Without being bound by any particular theory, such a thermodynamic nature indicates a polymer-like behavior of the peptide along with the plasticizing effect of the water [Desloir et al. J. Appl. Polym. Sci. 136, 1-6 (2019)]. The increase in the Tg value arises from stronger intermolecular interactions in the form of hydrogen bonding between the molecules, whereby higher content of water molecules provides the peptide with better deformation capability and mobility by decreasing intermolecular interactions, demonstrating the plasticizing role of water, e.g., as schematically illustrated in FIG. 6G.

Assuming that the peptide glass has lost most of the plasticizing water molecules, it should approach its highest hardness properties. Nanoindentation revealed hardness of 747±120 MPa and reduced modulus of elasticity of 12±1 GPa which is comparable to known polymeric glasses.

FIG. 7 presents photographs of YYY peptides assembled under ambient conditions, following exposure to extreme dry conditions generated by addition of silica beads desiccant to a sealed environment (upper panel). As can be seen, cracks propagate within the glassy material within second.

As the presence of water molecules affects the glass transition of the peptide, due to the high rate of the change in the thermodynamic properties caused by loss of water, the resulting cracked glass-like peptide may be paralleled to a thermal shock caused by fast cooling of a glass.

Surprisingly, as can further be seen in FIG. 7, lower panel, exposure of the cracked glassy material to a saturated humid environment generated by addition of a water reservoir to a sealed surrounding, resulted in the glass self-healing without any marks of the cracks.

These observations suggest that a reversible process occurs upon hydration/dehydration of the YYY peptide material, indicating a self-healing behavior. Without being bound to any particular theory, it is assumed that in a water saturated environment, water diffusion is involved in the healing mechanism by increasing the hydration state, enabling molecular mobility.

Studying the interactions of the peptide with hydrophobic substrates such as Teflon® and PDMS substrates exposed another self-healing mechanism.

In these studies, it has been uncovered that while the dried YYY solutions adhere strongly to hydrophilic surfaces, the dried solutions are repelled when applied to hydrophobic surfaces and can be detached easily as an intact solid once dehydrated, as is schematically illustrated in FIG. 8A, left and middle schematic illustrations. Under persistent mechanical stress applied by hydrophobic substrates, the glass-like YYY peptide material exhibits creeping behavior [Frankberg et al. Science 366, 864-869 (2019)], as is schematically illustrated in FIG. 8A, right.

As shown in FIGS. 8B-E, through a creeping mechanism activated by the external loading of a top PDMS substrate, the peptide glass could self-heal a pyramidal indentation to obtain a uniform and flat surface without any mark of the former indentation pattern, after 5 days. After a pyramidal indentation was applied and resulted in a pyramidal void at the surface, the peptide glass sample was left between two PDMS substrates, one at bottom and another at the top. The bottom and top substrates were connected at the edges, to allow the application of a constant external load on the glass sample.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1-35. (canceled)

36. A composition comprising a plurality of peptides and an aqueous solvent, wherein in at least a portion of said plurality peptides, each peptide is independently an aromatic peptide of from 2 to 6 amino acid residues, in which at least two of said amino acid residues are each independently an aromatic amino acid residue, wherein at least one of said aromatic amino acid residues is tyrosine or an analog thereof, and wherein said aromatic peptide features a solubility of at least 100 mg/ml, or at least 200 mg/ml, or at least 500 mg/ml or at least 1,000 mg/ml, at 25° C., in said solvent.

37. The composition of claim 36, wherein each of said aromatic peptides is independently an aromatic di-peptide or an aromatic tri-peptide.

38. The composition of claim 36, wherein each of said aromatic amino acid residues in each of said aromatic peptides is independently selected from a phenylalanine residue and a tyrosine residue and analogs thereof.

39. The composition of claim 36, wherein at least 50% of the aromatic amino acid residues in each of said aromatic peptides are each independently selected from tyrosine residues and analogs thereof.

40. The composition of claim 36, wherein each of said aromatic peptides is independently selected from FY, YF, YY, FFY, YFF, FYY, YFY, YYF and YYY.

41. The composition of claim 36, being an aqueous solution.

42. A material comprising a plurality of peptides assembled into a non-crystalline structure, wherein in at least a portion of said plurality peptides, each peptide is independently an aromatic peptide of from 2 to 6 amino acid residues, in which at least two of said amino acid residues are each independently an aromatic amino acid residue, wherein at least one of said aromatic amino acid residues is tyrosine or an analog thereof, and wherein said aromatic peptide features a solubility of at least 100 mg/ml, or at least 200 mg/ml, or at least 500 mg/ml or at least 1,000 mg/ml, at 25° C., in said solvent.

43. The material of claim 42, being a transparent material.

44. The material of claim 42, being a glassy material characterized by a glass transition temperature (Tg) higher than room temperature, or higher than 30° C.

45. The material of claim 42, characterized by:
Tg that ranges from room temperature to about 50° C. in an environment featuring a relative humidity of at least 50%; and/or
Tg of at least 50, or at least 100, ° C.;
hardness that ranges from 500 to 1,000 MPa; and
reduced modulus of elasticity that ranges from 1 to 20 GPa,
in an environment featuring a relative humidity lower than 30%.

46. The material of claim 42, wherein said self-assembled structure further comprises water molecules associated with at least a portion of said peptides, and wherein:
when a mol ratio of said water molecules and said peptides is higher than 5:1 or higher than 10:1, the material is characterized by Tg that ranges from room temperature to about 50° C.; and/or
when a mol ratio of said water molecules and said peptides is lower than 5:1, the material is characterized by at least one of:
Tg of at least 50, or at least 100, ° C.;
hardness that ranges from 500 to 1,000 MPa; and
modulus of elasticity that ranges from 1 to 20 GPa.

47. The material of claim 42, being a self-healing glassy material, capable of diminishing cracks formed therein by exposure to an environment that features a relative humidity higher than 50%.

48. A method of forming a layer of a rigid, non-crystalline peptide material on a surface of a substrate, the method comprising applying the composition of claim 36 on the surface of the substrate to thereby form a layer of the material on the surface of the substrate.

49. A substrate having applied on at least a portion of a surface thereof the material of claim 42.

50. A method of adhering at least two substrates to one another, the method comprising contacting at least a portion of each of the substrates with the composition of claim 36.

51. An article-of-manufacturing comprising at least two substrates and the material of claim 42 being in contact with at least a portion of a surface of each of said at least two substrates.

52. An article-of-manufacturing comprising the material of claim 42.

53. The article-of-manufacturing of claim 52, being or comprising an optical lens.

54. A biodegradable self-healing, glassy material.
